(19) United States
(12) Patent Application Publication
(10) Pub. No.: US 2025/0233609 A1
(43) Pub. Date: Jul. 17, 2025

(54) ELECTRONIC DEVICE AND OPERATION METHOD FOR PERFORMING BACK-OFF ON BASIS OF SAR

(71) Applicant: Samsung Electronics Co., Ltd., Suwon-si (KR)

(72) Inventors: Jaemoon CHA, Suwon-si (KR); Jaewoo PARK, Suwon-si (KR); Yeonjoo LEE, Suwon-si (KR); Youngkwon LEE, Suwon-si (KR); Euichang JUNG, Suwon-si (KR)

(21) Appl. No.: 19/170,527

(22) Filed: Apr. 4, 2025

Related U.S. Application Data
(63) Continuation of application No. PCT/KR2023/015250, filed on Oct. 4, 2023.

(30) Foreign Application Priority Data
Oct. 4, 2022 (KR) 10-2022-0126278
Nov. 22, 2022 (KR) 10-2022-0157734

(51) Int. Cl. H04B 1/3827; H04W 52/36; H04W 76/20

(52) U.S. Cl. CPC H04B 1/3838; H04W 52/367; H04W 76/20

(57) ABSTRACT

A method and an electronic device are provided, The electronic device includes a wireless fidelity (WiFi) module for WiFi communication, memory storing one or more computer programs, and at least one communication processor, for at least one cellular communication, communicatively coupled to the WiFi module and the memory, wherein the one or more computer programs include computer-executable instructions that, when executed by the at least one communication processor individually or collectively, cause the electronic device to, based on identifying that WiFi module is in an OFF state, assign an overall specific absorption rate (SAR) margin assigned to the electronic device for a first period to the at least one cellular communication, based on identifying that the WiFi module is in an ON state and a cumulative SAR value consumed by the WiFi module is less than or equal to a threshold value, assign a first amount of the SAR margin assigned for the first period to the WiFi communication and assign a remaining amount excluding the first amount to the at least one cellular communication, and based on identifying that the WiFi module is in an ON state and the cumulative SAR value consumed by the WiFi module exceeds the threshold value, assign a second amount of the SAR margin assigned for the first period to the WiFi communication, which is greater than the first amount, and assign a remaining amount excluding the second amount to the at least one cellular communication.

### CROSS-REFERENCE TO RELATED APPLICATION(S)

This application is a continuation application, claiming priority under 35 U.S.C. § 365(c), of an International application No. PCT/KR2023/015250, filed on Oct. 4, 2023, which is based on and claims the benefit of a Korean patent application number 10-2022-0126278, filed on Oct. 4, 2022, in the Korean Intellectual Property Office, and of a Korean patent application number 10-2022-0157734, filed on Nov. 22, 2022, in the Korean Intellectual Property Office, the disclosure of each of which is incorporated by reference herein in its entirety.

### BACKGROUND

### 1. Field

The disclosure relates to an electronic device that backs off, based on a specific absorption rate (SAR), a maximum transmission power limit (MTPL) or transmission power, and an operation method thereof.

### 2. Description of Related Art

Electronic devices that support both cellular communication and IEEE 802.11-based communication (hereinafter, referred to as wireless fidelity (WiFi) communication) are widely provided. An electronic device may transmit a cellular communication-based transmission radio frequence (RF) signal and may transmit a WiFi communication-based transmission RF signal. When a distance between an antenna to which a cellular communication-based transmission RF signal is applied and an antenna to which a WiFi communication-based transmission RF signal is applied is less than a predetermined distance, the sum of SARs corresponding to both the transmission RF signals needs to satisfy SAR-related regulations. An electromagnetic wave corresponding to a cellular communication-based transmission RF signal and an electromagnetic wave corresponding to a WiFi communication and/or Bluetooth-based transmission RF signal may be emitted from respective antennas simultaneously or in different times. Accordingly, an SAR corresponding to a cellular communication-based transmission RF signal and an SAR corresponding to a WiFi communication-based transmission RF signal may need to satisfy time average SAR regulations. An SAR margin higher than or equal to a predetermined value may need to be assigned to a predetermined type of communication so that a transmission power of an RF signal for the corresponding communication may be higher than or equal to a predetermined value. For example, when both cellular communication and WiFi communication are activated for an electronic device that supports both the cellular communication and WiFi communication, an SAR margin greater than or equal to a predetermined value needs to be assigned to both communications. For example, for the electronic device, a maximum SAR value assigned for a predetermined time window may need to be appropriately distributed to both communications.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide an electronic device that backs off, based on a specific absorption rate (SAR), a maximum transmission power limit (MTPL) or transmission power, and an operation method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a WiFi module for WiFi communication, memory storing one or more computer programs, and at least one communication processor, for at least one cellular communication, communicatively coupled to the WiFi module and the memory, wherein the one or more computer programs include computer-executable instructions that, when executed by the at least one communication processor individually or collectively, cause the electronic device to, based on identifying that the WiFi module is in an OFF state, assign an overall specific absorption rate (SAR) margin assigned to the electronic device for a first period to the at least one cellular communication, based on identifying that the WiFi module is in an ON state and a cumulative SAR value consumed by the WiFi module is less than or equal to a threshold value, assign a first amount of the SAR margin assigned for the first period to the WiFi communication and assign a remaining amount excluding the first amount to the at least one cellular communication, and based on identifying that the WiFi module is in an ON state and the cumulative SAR value consumed by the WiFi module exceeds the threshold value, assign a second amount of the SAR margin assigned for the first period to the WiFi communication, which is greater than the first amount, and assign a remaining amount excluding the second amount to the at least one cellular communication.

In accordance with another aspect of the disclosure, a method performed by an electronic device performing WiFi communication and cellular communication is provided. The method includes, based on identifying that the WiFi communication is not performed, assigning, by the electronic device, an overall specific absorption rate (SAR) margin assigned to the electronic device for a first period to the cellular communication, based on identifying that the WiFi communication is performed and a cumulative SAR value consumed by performing the WiFi communication is less than or equal to a threshold value, assigning, by the electronic device, a first amount of the SAR margin assigned for the first period to the WiFi communication, and assigning a remaining amount excluding the first amount to the cellular communication, and based on identifying that the WiFi communication is performed and the cumulative SAR value consumed by performing the WiFi communication exceeds the threshold value, assigning, by the electronic device, a second amount of the SAR margin assigned for the first period, which is greater than the first amount, to the WiFi communication and assigning the remaining amount excluding the second amount to the cellular communication.

In accordance with another aspect of the disclosure, one or more non-transitory computer-readable storage media storing one or more computer programs including computer-executable instructions that, when executed by at least one communication processor of an electronic device performing wireless fidelity (WiFi) communication and cellular communication, cause the electronic device to perform operations are provided. The operations include based on identifying that WiFi communication is not performed, assigning, by the electronic device, an overall specific absorption rate (SAR) margin assigned to the electronic device for a first period to the cellular communication, based on identifying that the WiFi communication is performed and a cumulative SAR value consumed by performing the WiFi communication is less than or equal to a threshold value, assigning, by the electronic device, a first amount of the SAR margin assigned for the first period to the WiFi communication, and assigning a remaining amount excluding the first amount to the cellular communication, and based on identifying that the WiFi communication is performed and the cumulative SAR value consumed by performing the WiFi communication exceeds the threshold value, assigning, by the electronic device, a second amount of the SAR margin assigned for the first period, which is greater than the first amount, to the WiFi communication and assigning a remaining amount excluding the second amount to the cellular communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a block diagram of an electronic device for supporting legacy network communication and fifth generation (5G) network communication according to an embodiment of the disclosure;

FIG. 2B is a block diagram of an electronic device for supporting legacy network communication and 5G network communication according to an embodiment of the disclosure;

FIG. 3A is a flowchart illustrating an operation method of an electronic device according to an embodiment of the disclosure;

FIG. 3B is a diagram illustrating a transmission power and an SAR over time according to an embodiment of the disclosure;

FIGS. 4A, 4B, and 4C are graphs of transmission powers over time according to various embodiments of the disclosure;

FIGS. 4D and 4E are tables of transmission powers over time according to various embodiments of the disclosure;

FIG. 5A is a block diagram of an electronic device including a WiFi module according to an embodiment of the disclosure;

FIG. 5B is a flowchart illustrating an operation of a WiFi module and a communication processor according to an embodiment of the disclosure;

FIG. 5C is a flowchart illustrating an operation of a WiFi module and a communication processor according to an embodiment of the disclosure;

FIG. 5D is a diagram illustrating an SAR that WiFi uses when performing a random access channel (RACH) operation, a comparative example for comparison according to an embodiment of the disclosure;

FIG. 5E is a diagram illustrating a magnitude of an SAR margin for each communication according to an embodiment of the disclosure;

FIG. 6A is a diagram illustrating an operation of assigning a magnitude of an SAR margin of WiFi communication according to an embodiment of the disclosure;

FIG. 6B is a flowchart illustrating an operation method of an electronic device according to an embodiment of the disclosure;

FIG. 7 is a diagram illustrating a cumulative SAR as an SAR margin for WiFi communication is assigned according to an embodiment of the disclosure;

FIG. 8 is a diagram illustrating a cumulative SAR of cellular communication as an SAR margin for WiFi communication changes according to an embodiment of the disclosure;

FIG. 9 is a diagram illustrating a cumulative SAR of cellular communication as an SAR margin for WiFi communication changes according to an embodiment of the disclosure;

FIG. 10 is a diagram illustrating a cumulative SAR of cellular communication as an SAR margin for WiFi communication changes according to an embodiment of the disclosure;

FIG. 11 is a diagram illustrating an operation of assigning a magnitude of an SAR margin when a voice call operation of WiFi communication is performed according to an embodiment of the disclosure;

FIG. 12 is a diagram illustrating a cumulative SAR as a voice call operation of WiFi communication is performed according to an embodiment of the disclosure;

FIG. 13 is a diagram illustrating an operation of assigning a magnitude of an SAR margin when a voice call operation of cellular communication is performed while WiFi is connected according to an embodiment of the disclosure;

FIG. 14 is a diagram illustrating a cumulative SAR as a voice call operation of cellular communication is performed while WiFi is connected according to an embodiment of the disclosure;

FIG. 15A is a diagram illustrating a cumulative SAR when a WiFi SAR margin is gradually increased according to an embodiment of the disclosure;

FIG. 15B is a diagram illustrating a cumulative SAR of cellular communication when a WiFi SAR margin is gradually increased according to an embodiment of the disclosure;

FIG. 16A is a diagram illustrating the amount of SAR usage of each communication when an SAR margin is shared between WiFi communication and cellular communication in the same time scale according to an embodiment of the disclosure;

FIG. 16B is a diagram illustrating the amount of SAR usage of each communication when an SAR margin is shared between WiFi communication and cellular communication in the same time scale according to an embodiment of the disclosure;

FIG. 17A is a diagram illustrating the amount of SAR usage of each communication when an SAR margin is shared between WiFi communication and cellular communication in different time scales according to an embodiment of the disclosure;

FIG. 17B is a diagram illustrating the amount of SAR usage of each communication when an SAR margin is shared between WiFi communication and cellular communication in different time scales according to an embodiment of the disclosure;

FIG. 18 is a flowchart illustrating an operation method of an electronic device according to an embodiment of the disclosure;

FIG. 19 is a flowchart illustrating an operation method of an electronic device according to an embodiment of the disclosure;

FIG. 20A is a flowchart illustrating an operation method of an electronic device according to an embodiment of the disclosure; and

FIG. 20B is a diagram illustrating an SAR that occurs based on Bluetooth communication according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

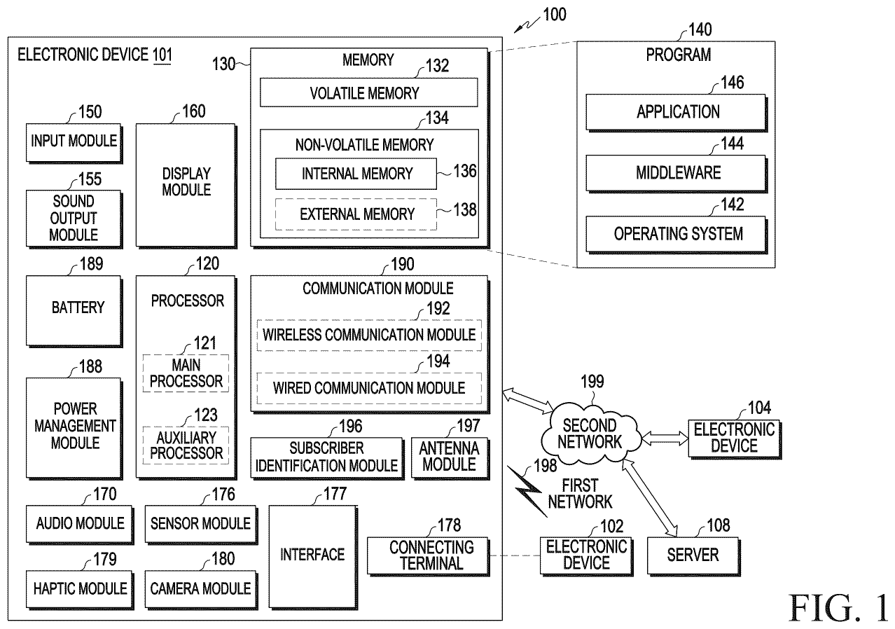

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

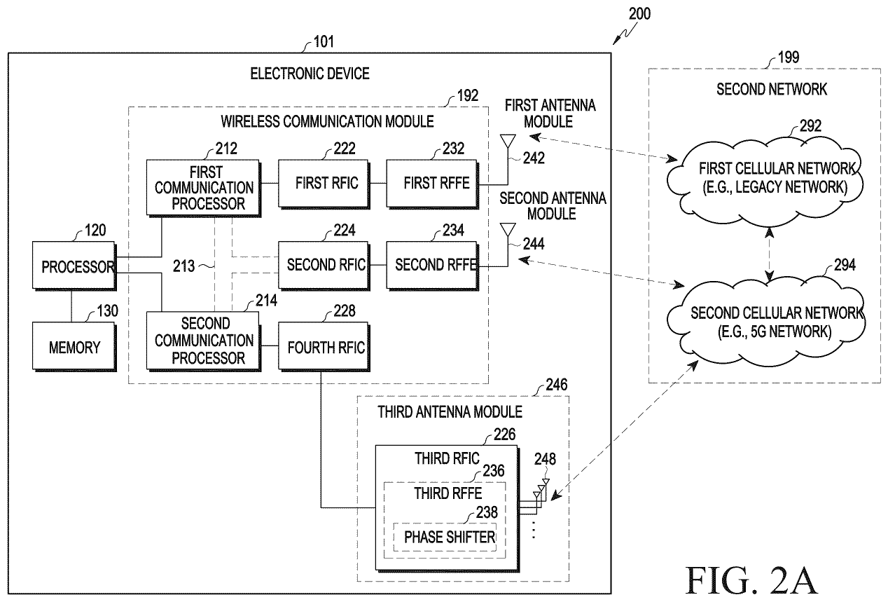

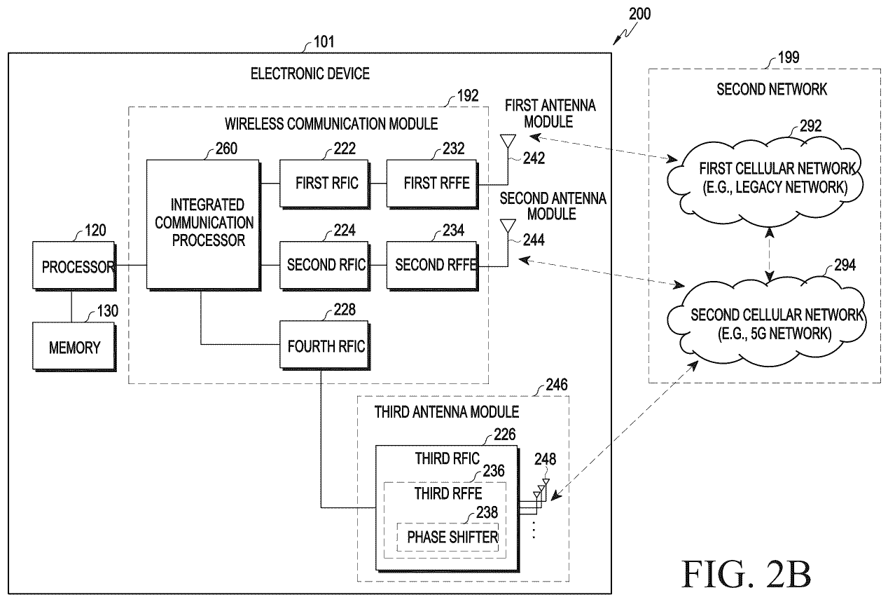

FIG. 2A is a block diagram 200 of an electronic device for supporting legacy network communication and 5G network communication according to an embodiment of the disclosure.

Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include the processor 120 and the memory 130. The second network 199 may include a first cellular network 292 and a second cellular network 294. According to another embodiment of the disclosure, the electronic device 101 may further include at least one component among the components illustrated in FIG. 1, and the second network 199 may further include at least one other network. According to an embodiment of the disclosure, the first communication processor 212, the second communication processor 214, the first RFIC 222, the second RFIC 224, the fourth RFIC 228, the first RFFE 232, and the second RFFE 234 may be at least part of the wireless communication module 192. According to another embodiment of the disclosure, the fourth RFIC 228 may be omitted, or may be included as part of the third RFIC 226.

The first communication processor 212 may establish a communication channel of a band to be used for wireless communication with the first cellular network 292, and may support legacy network communication via the established communication channel. According to various embodiments of the disclosure, the first cellular network may be a legacy network including a second generation (2G), third generation (3G), 4G, or long term evolution (LTE) network. The second communication processor 214 may establish a communication channel corresponding to a designated band (e.g., approximately 6 GHz to 60 GHZ) among bands to be used for wireless communication with the second cellular network 294, and may support 5G network communication via the established channel. According to various embodiments of the disclosure, the second cellular network 294 may be a 5G network defined in third generation partnership project (3GPP). Additionally, according to an embodiment of the disclosure, the first communication processor 212 or the second communication processor 214 may establish a communication channel corresponding to another designated band (e.g., approximately 6 GHz or lower) among bands to be used for wireless communication with the second cellular network 294, and may support 5G network communication via the established communication channel.

The first communication processor 212 may perform data transmission or reception with the second communication processor 214. For example, data which has been classified to be transmitted via the second cellular network 294 may be changed to be transmitted via the first cellular network 292. In this instance, the first communication processor 212 may receive transmission data from the second communication processor 214. For example, the first communication processor 212 may perform data transmission or reception with the second communication processor 214 via an inter-processor interface 213. The inter-processor interface 213 may be embodied as, for example, a universal asynchronous receiver/transmitter (UART) (e.g., a high speed-UART (HS-UART)) or a peripheral component interconnect bus express (PCIe) interface, but the type of interface is not limited. Alternatively, the first communication processor 212 and the second communication processor 214, for example, may exchange control information and packet data information by using shared memory. The first communication processor 212 may perform, with the second communication processor 214, transmission or reception of various types of information, such as sensing information, information on an output strength, and resource block (RB) allocation information.

Depending on the implementation, the first communication processor 212 may not be directly connected to the second communication processor 214. In this instance, the first communication processor 212 may perform data transmission or reception with the second communication processor 214 via the processor 120 (e.g., application processor). For example, the first communication processor 212 and the second communication processor 214 may perform data transmission or reception with the processor 120 (e.g., application processor) via an HS-UART interface or a PCIe interface, but the type of interface is not limited. Alternatively, the first communication processor 212 and the second communication processor 214 may exchange control information and packet data information with the processor 120 (e.g., application processor) using shared memory.

FIG. 2B is a block diagram of an electronic device for supporting legacy network communication and 5G network communication, according to an embodiment of the disclosure.

Referring to FIG. 2B, according to an embodiment of the disclosure, the first communication processor 212 and the second communication processor 214 may be embodied in a single chip or a single package. According to various embodiments of the disclosure, the first communication processor 212 or the second communication processor 214 may be embodied in a single chip or a single package, together with the processor 120, the sub-processor 123, or the communication module 190. Referring to FIG. 2B, a communication processor 260 may support all functions for communication with the first cellular network 292 and the second cellular network 294.

In the case of transmission, the first RFIC 222 may convert a baseband signal generated by the first communication processor 212 into a radio frequency (RF) signal in the range of approximately 700 MHz to 3 GHZ, which is used for the first cellular network 292 (e.g., legacy network). In the case of reception, an RF signal is obtained from the first network 292 (e.g., legacy network) via an antenna (e.g., first antenna module 242), and may be preprocessed via an RFFE (e.g., first RFFE 232). The first RFIC 222 may convert the preprocessed RF signal into a baseband signal so that the signal is processed by the first communication processor 212.

In the case of transmission, the second RFIC 224 may convert a baseband signal generated by the first communication processor 212 or the second communication processor 214 into an RF signal (hereinafter, 5G Sub6 RF signal) in an Sub6 band (e.g., approximately 6 GHz or less) used in the second cellular network 294 (e.g., 5G network). In the case of reception, a 5G Sub6 RF signal is obtained from the second cellular network 294 (e.g., 5G network) via an antenna (e.g., second antenna module 244), and may be preprocessed by an RFFE (e.g., second RFFE 234). The second RFIC 224 may convert the preprocessed 5G Sub6 RF signal into a baseband signal so that the signal may be processed by a corresponding communication processor among the first communication processor 212 or the second communication processor 214.

The third RFIC 226 may convert a baseband signal generated by the second communication processor 214 into an RF signal (hereinafter, 5G Above6 RF signal) of a 5G Above6 band (e.g., approximately 6 GHz to 60 GHZ) to be used for the second cellular network 294 (e.g., 5G network). In the case of reception, a 5G Above6 RF signal may be received from the second cellular network 294 (e.g., 5G network) via an antenna (e.g., antenna 248), and may be preprocessed by the third RFFE 236. The third RFIC 226 may convert the preprocessed 5G Above6 RF signal into a baseband signal so that the signal may be processed by the second communication processor 214. According to an embodiment of the disclosure, the third RFFE 236 may be embodied as part of the third RFIC 226.

The electronic device 101, according to an embodiment of the disclosure, may include the fourth RFIC 228, separately from the third RFIC 226 or as part of the third RFIC 226. In this instance, the fourth RFIC 228 may convert a baseband signal generated by the second communication processor 214 into an RF signal (hereinafter, IF signal) in an intermediate frequency band (e.g., approximately 9 GHz to 11 GHZ), and may transfer the IF signal to the third RFIC 226. The third RFIC 226 may convert the IF signal into a 5G Above6 RF signal. In the case of reception, a 5G Above6 RF signal may be received from the second cellular network 294 (e.g., 5G network) via an antenna (e.g., antenna 248), and may be converted into an IF signal by the third RFIC 226. The fourth RFIC 228 may convert an IF signal into a baseband signal so that the second communication processor 214 may process the signal.

According to an embodiment of the disclosure, the first RFIC 222 and the second RFIC 224 may be embodied as at least part of a single chip or a single package. According to various embodiments of the disclosure, if the first RFIC 222 and the second RFIC 224 are embodied as a single chip or a single package in FIG. 2A or 2B, they may be embodied as an integrated RFIC. In this instance, the integrated RFIC may be connected to the first RFFE 232 and the second RFFE 234, may convert a baseband signal into a signal in a band supported by the first RFFE 232 and/or the second RFFE 234, and may transmit the converted signal to one of the first RFFE 232 and the second RFFE 234. According to an embodiment of the disclosure, the first RFFE 232 and the second RFFE 234 may be embodied as at least part of a single chip or a single package. According to an embodiment of the disclosure, at least one of the first antenna module 242 or the second antenna module 244 may be omitted, or may be combined with another antenna module, so as to process RF signals of a plurality of corresponding bands.

According to an embodiment of the disclosure, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., lower part) of a second substrate (e.g., sub PCB) different from the first substrate, and the antenna 248 is disposed in another part (e.g., upper part), so that the third antenna module 246 may be formed. When the third RFIC 226 and the antenna 248 are disposed in the same substrate, the length of a transmission line therebetween may be reduced. For example, this may reduce a loss (e.g., diminution) of a high-frequency band signal (e.g., approximately 6 GHz to 60 GHZ) used for 5G network communication, the loss being caused by a transmission line. Accordingly, the electronic device 101 may improve the quality or speed of communication with the second network 294 (e.g., 5G network).

According to an embodiment of the disclosure, the antenna 248 may be embodied as an antenna array including a plurality of antenna elements which may be used for beamforming. In this instance, the third RFIC 226 may be, for example, part of the third RFFE 236, and may include a plurality of phase shifters 238 corresponding to a plurality of antenna elements. In the case of transmission, each of the plurality of phase shifters 238 may shift the phase of a 5G Above6 RF signal to be transmitted to the outside of the electronic device 101 (e.g., a base station of the 5G network) via a corresponding antenna element. In the case of reception, each of the plurality of phase shifters 238 may shift the phase of a 5G Above6 RF signal received from the outside via a corresponding antenna element into the same or substantially the same phase. This may enable beamforming-based transmission or reception between the electronic device 101 and the outside.

The second cellular network 294 (e.g., 5G network) may operate independently (e.g., stand-alone (SA)) from the first cellular network 292 (e.g., legacy network), or may operate by being connected thereto (e.g., non-standalone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access the access network of the 5G network, and may access an external network (e.g., the Internet) under the control of the core network (e.g., evolved packed core (EPC)) of the legacy network. Protocol information (e.g., LTE protocol information) for communication with the legacy network or protocol information (e.g., new radio (NR) protocol information) for communication with the 5G network may be stored in the memory 230, and may be accessed by another component (e.g., processor 120, first communication processor 212, or second communication processor 214).

The communication processor (e.g., at least one of the first communication processor 212, the second communication processor 214, or the integrated communication processor 260) may be embodied as an integrated circuit, and in this instance, may include at least one storage circuit storing at least one instruction that causes an operation to be performed according to various embodiments of the disclosure, and at least one processing circuit that implements at least one instruction.

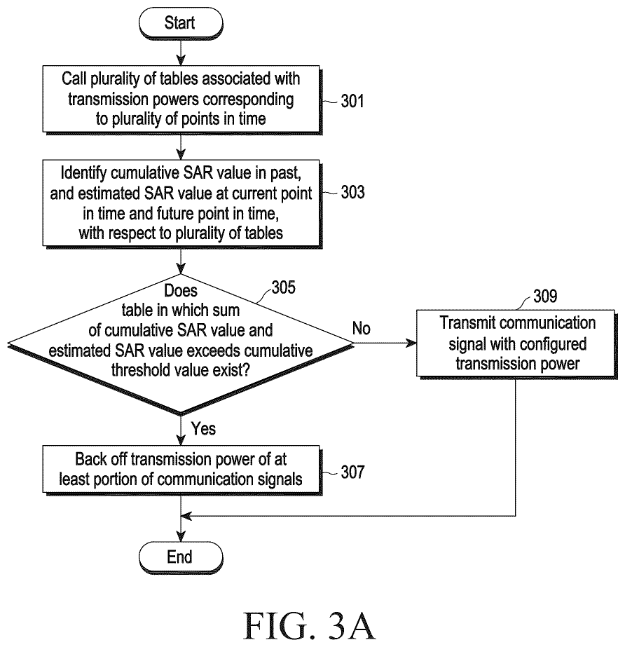

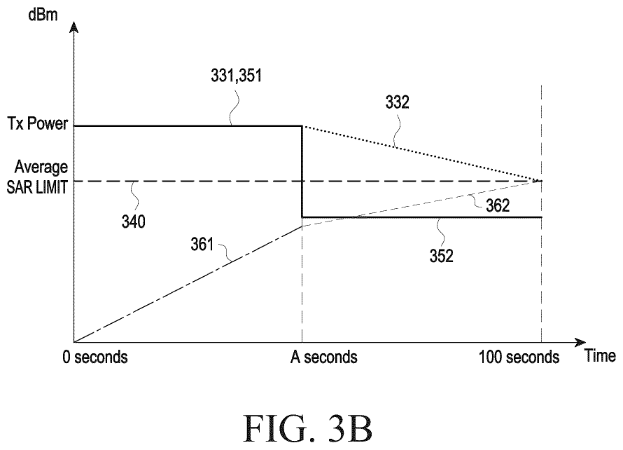

FIG. 3A is a flowchart illustrating an operation method of an electronic device according to an embodiment of the disclosure.

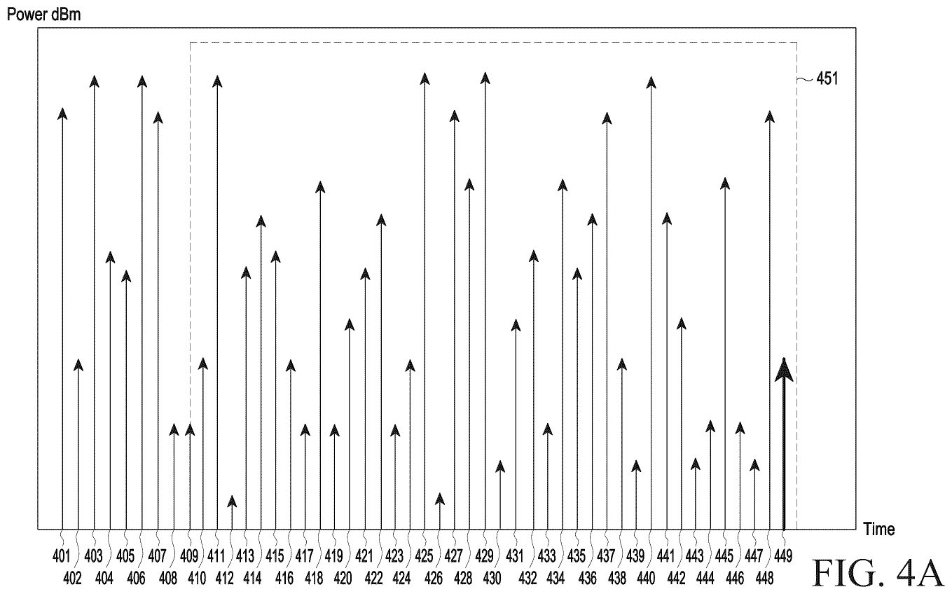

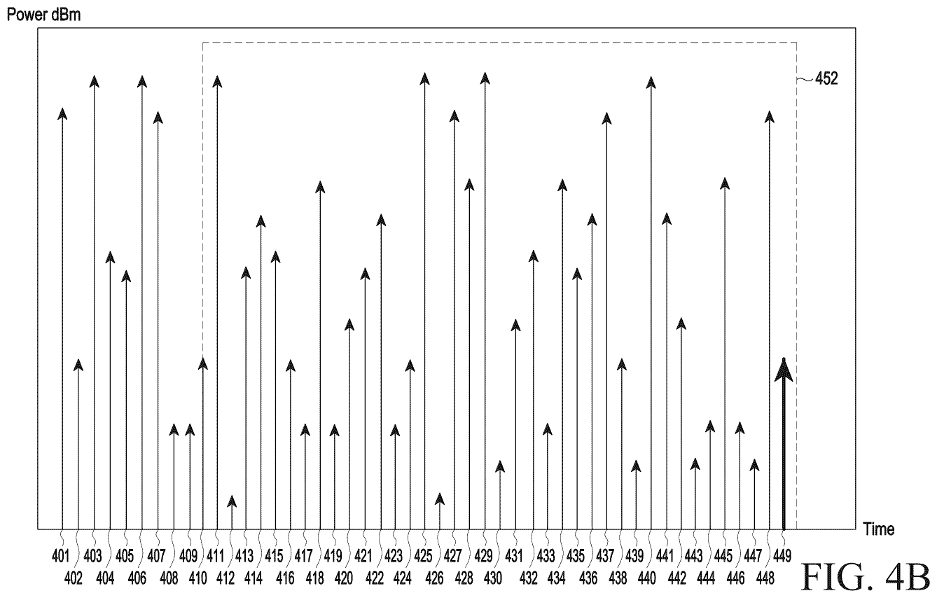

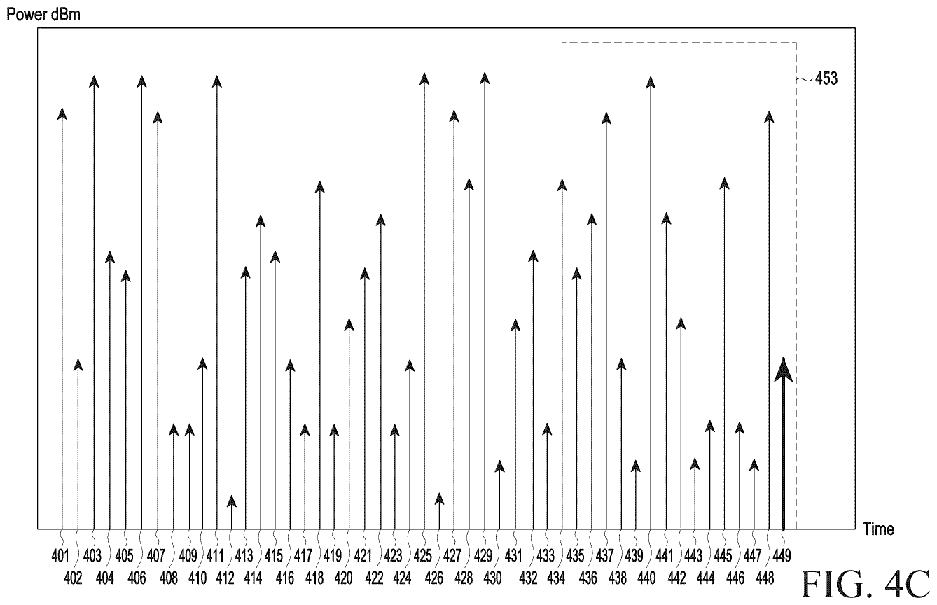

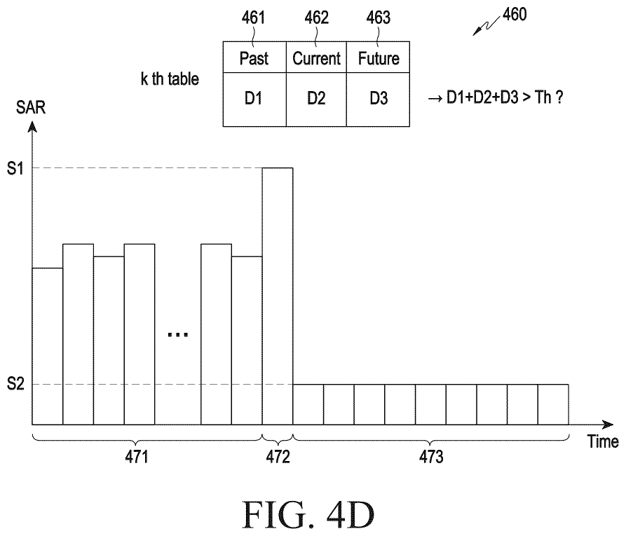

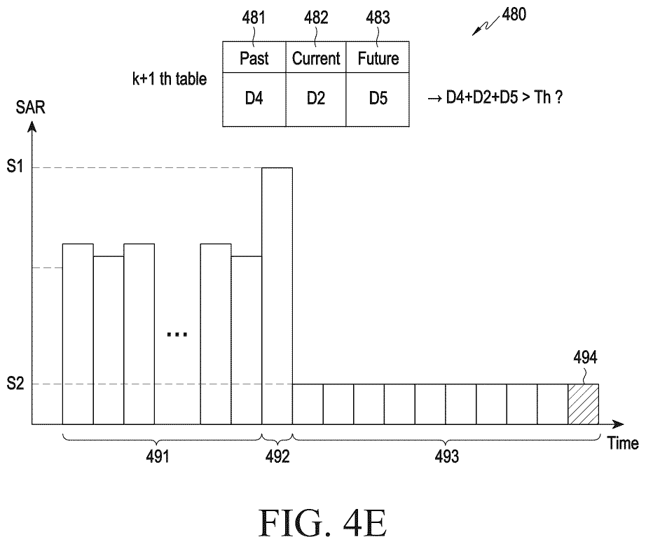

The embodiment of FIG. 3A will be described with reference to FIGS. 3B, 4A, 4B, 4C, 4D, and 4E.

FIG. 3B is a diagram illustrating a transmission power and an SAR over time according to an embodiment of the disclosure.

FIGS. 4A, 4B, and 4C are graphs illustrating transmission powers over time according to various embodiments of the disclosure.

FIGS. 4D and 4E are tables associated with transmission powers over time according to various embodiments of the disclosure.

According to various embodiments of the disclosure, the electronic device 101 (e.g., at least one of the processor 120, the first communication processor 212, the second communication processor 214, or the integrated communication processor 260) may call a plurality of tables associated with transmission powers (or transmission magnitudes) corresponding to a plurality of points in time in operation 301. Before describing an embodiment associated with FIG. 3A, terms in Table 1 shown below are defined.

TABLE 1

| | |
|---|---|
| a. | Normal MAX Power: a maximum transmission power when a margin of an |
| | SAR remains. |
| b. | Normal Max SAR: a magnitude of an SAR occurring in the case of operation at |
| | a normal max power. |
| c. | Backoff MAX Power: a maximum transmission power when backoff is |
| | performed since a margin of an SAR is insufficient. |
| d. | Backoff Max SAR: a magnitude of an SAR occurring in the case of operation at |
| | a backoff max power. |
| e. | Measurement Time (T): a period for calculating a cumulative SAR or an |
| | average SAR. |
| f. | Measurement Period (P): a cycle (or time interval) for calculating an SAR. |
| g. | Number of Tables for Calculating an SAR: T/P − 1 |
| h. | Average SAR LIMIT: a maximum value to which an average SAR is limited |
| | during T. |
| i. | Average Time (A_Time): a time of measuring SARs cumulatively. |
| j. | Cumulative SAR: a sum of SARs accumulated during an average time. |
| k. | Max Cumulative SAR: average SAR LIMIT × measurement time. |
| l. | Average SAR: a magnitude of an average SAR used during an average time. |
| m. | Tx Room: Max cumulative SAR − cumulative SAR, SAR remaining after |
| | use. |
| n. | Remain Time (R_Time): a total measurement time − a time (A_Time) spent in |
| | measuring an SAR up to the present. |

In order to describe the table, reference will be made to FIGS. 4A, 4B, and 4C. Referring to FIG. 4A, there is provided a graph including transmission powers associated with a plurality of points 401 to 449 in time. A cumulative SAR (e.g., cumulative SAR in Table 1) during a measurement time (e.g., measurement time (T) in Table 1), for example, a measurement time including 50 points in time, may need to maintain a value less than or equal to a maximum cumulative SAR (e.g., max cumulative SAR in Table 1). The electronic device 101, for example, may determine a transmission power of a communication signal to be transmitted at the current point 449 in time so that an cumulative SAR, obtained based on a cumulative SAR corresponding to the current point 449 in time and past points 409 to 448 in time (e.g., average time in Table 1) and a cumulative SAR corresponding to 9 future points (not illustrated) in time (e.g., remain time in Table 1), is maintained as a value less than or equal to the maximum cumulative SAR. In addition, as illustrated in FIG. 4B, the electronic device 101 may identify transmission powers 452 shifted by one time point from the transmission powers 451 at the current point 449 in time and the past points 409 to 448 in time of FIG. 4A. Shifting by one time point may mean that data at the earliest time point in the past (e.g., the point 409 of FIG. 4A) is not applied. The number of transmission powers 452 at the current point 449 in time and the past points 410 to 448 in time is 40, and may be one smaller than 41 which is the number of transmission powers 451 of FIG. 4A. The electronic device 101 may determine the transmission power at the current point 449 in time so that the sum of SARs at the transmission powers 452 and SARs estimated at additional 10 future points in time is maintained as a value less than or equal to the maximum cumulative SAR. As illustrated in FIG. 4C, the electronic device 101 may identify transmission powers 453 at the current time point 449 and the past points 434 to 448 in time, which are shifted by 25 points in time from the transmission powers 451. The number of the transmission powers 453 is 16, and may be 25 smaller than 41 which is the number of the transmission powers 451 of FIG. 4A. The electronic device 101 may determine the transmission power at the current point 449 in time so that the sum of SARs at the transmission powers 453 and SARs estimated at additional 34 future points in time is maintained as a value less than or equal to the maximum cumulative SAR. Although not illustrated, the electronic device 101 may manage a plurality of graphs which have one-shift differences from each other. A cycle for calculating an SAR is a measurement period (P) in Table 1, and for example, may be an interval between transmission powers shown in FIGS. 4A, 4B, and 4C. The electronic device 101 may calculate and/or manage (T/P−1) tables at a predetermined time point. Hereinafter, with reference to FIGS. 4D and 4E, a configuration of identifying an estimated SAR value will be described. Referring to FIG. 4D, the electronic device 101 may identify a kth SAR table 460. The kth SAR table 460 may include D1 that is a cumulative SAR value 461 corresponding to at least one past time point, D2 that is the maximum SAR value 462 at the current time point, and D3 that is an estimated SAR value 463 corresponding to at least one future time point. Referring to a graph, a cumulative value of the SARs corresponding to the at least one past point 471 in time may be D1. D1 that is the cumulative SAR value 461 corresponding to at least one past time point may be identified based on an antenna configuration. The number of at least one past time point may be one smaller than the total number of points in time (e.g., 100) corresponding to a measurement time (e.g., 50 seconds) in the first table. N that is the total number of points in time (e.g., 100) may be obtained by dividing the measurement time by a sampling interval (or a shift interval). Accordingly, in a kth table, the number of at least one past time point may be k smaller than the total number of points in time. The electronic device 101 may identify D1 that is a cumulative SAR value of N-k past points 471 in time. The electronic device 101 may use the maximum value (S1) of an SAR for a current point 472 in time. The maximum value (S1) of an SAR (e.g., a normal max SAR in Table 1) may be an SAR value corresponding to a maximum transmission power (e.g., normal max power in Table 1) designated by the electronic device 101. According to another embodiment of the disclosure, for the current point 472 in time, an SAR value at a time point that is immediately before the current point 472 in time may be used. According to another embodiment of the disclosure, for the current point 472 in time, an average value of SARs at the past points 471 in time of the current point 472 in time may be used. For at least one future point 473 in time, the electronic device 101 may calculate a sum of SAR values (S2) (e.g., backoff max SAR in Table 1) at backed-off transmission powers (e.g., backoff max power in Table 1). The electronic device 101 may identify D3 as a cumulative SAR for at least one future point 473 in time. In the kth table, the number of the at least one future time point may be k−1. Accordingly, with reference to the kth table, the electronic device 101 may identify whether the total sum (D1+D2+D3) of SARs corresponding to N points in time, which include the N-k past points in time, one current time point, and k−1 future points in time, exceeds a maximum cumulative SAR. When it is identified as exceeding, the electronic device 101 may back off the transmission power at the current time point. Referring to FIG. 4E, the electronic device 101 may identify a k+1th table 480. The electronic device 101 may identify, from the k+1th table 480, D4 that is a cumulative SAR value 481 corresponding to at least one past time point, D2 that is a maximum SAR value 482 at the current time point, and D5 that is an estimated SAR value 483 corresponding to at least one future time point. The electronic device 101 may identify whether a cumulative SAR value of D4+D2+D5 exceeds the maximum cumulative SAR. In the k+1th table, the number of at least one past point 491 in time may be one smaller than the number of at least one past point 492 in time in the kth table. In the k+1th table, the number of at least one future point 493 in time may be one 494 greater than the number of at least one future point 473 in time in the kth table.

According to various embodiments of the disclosure, in operation 303, the electronic device 101 may identify a cumulative SAR value in the past, and an estimated SAR value at the current time point and a future time point, with respect to a plurality of tables corresponding to at least one future time point. With respect to the first table and a total of N−1 tables, shifted by i points in time (i is greater than or equal to 1 and less than N−2) from the first table, the electronic device 101 may identify a cumulative SAR value. In operation 305, the electronic device 101 may identify whether a table exists, in which a sum of a cumulative SAR value and an estimated SAR value exceeds a threshold value. When a table in which the sum exceeds the threshold value exists (Yes in operation 305), the electronic device 101 may back off one of transmission powers (or maximum transmission power limit (MTPL)) of at least a portion of communication signals in operation 307. Those skilled in the art may understand that the backoff of a transmission power in the document may be replaced with the backoff of an MTPL. When a table in which the sum exceeding the threshold value does not exist (No in operation 305), the electronic device 101 may transmit a communication signal at a configured transmission power in operation 309. In various embodiments of the disclosure, the backoff of a maximum value of a transmission power may be the backoff of a maximum value of a transmission power.

As described above, the electronic device 101 may determine a maximum value of a transmission power so that an average magnitude of SARs used during a measurement time does not exceed an average SAR limit. Alternatively, the electronic device 101 may determine a maximum value of a transmission power so that a cumulative SAR during a measurement time does not exceed a max cumulative SAR. The electronic device 101 may determine a maximum value of a maximum power for a next time interval at every P time. For example, a condition for operation at a normal max power during a next P time may be as follows.

Condition: Tx room>SAR (normal max SAR in Table 1) occurring in the case of operation at normal max power during next P+SAR (backoff max SAR in Table 1) occurring in the case of operation at backoff max power during (remain time−P)=P×normal max SAR+(remain time−P)×backoff max SAR.

In the condition, Tx Room may be a value obtained by subtracting a cumulative SAR up to the present from the max cumulative SAR. In the condition, (remain time−P) may be T−average time−P, and, for example, may be a future time point that has been described with reference to FIGS. 4A, 4B, 4C, 4D, and 4E. P may be a current time point. The average time may be a past time point. The fact that the condition is satisfied means that a table in which a cumulative SAR exceeds the max cumulative SAR does not exist, although the electronic device 101 configures a maximum transmission power of a normal max power during a P time. The fact that the condition is not satisfied means that there is the probability of having a table in which a cumulative SAR exceeding the max cumulative SAR exists when the electronic device 101 configures a maximum transmission power of a normal max power during a P time. In this instance, the electronic device 101 may configure a backoff max power as a maximum transmission power during the P time.

Table 2 below shows an example of variables and a condition.

TABLE 2
[Example of Variable Configuration]
i. Normal MAX Power: 23 dBm
ii. Backoff MAX Power: 20 dBm
iii. Measurement Time (T): 100 seconds
iv. Measurement Period (P): 0.5 seconds
v. Number of SAR Calculator tables: 199
vi. Average SAR LIMIT: 1.5 mW/g
vii. Max Cumulative SAR: 150 mW/g
viii. Normal Max SAR => SAR at 23 dBm: 2 mW/g
ix. Backoff Max SAR => SAR at 20 dBm: 1 mW/g
[Time point at which maximum power is switched from normal max power to
backoff max power] Average time × normal max power + (100 − average time) ×
backoff max power <= Time point at which cumulative max SAR is
satisfied = Average time × 2 mW/g + (100 − average time) × 1 mW/g <= 150
mW/g <=> Average time <=50

In the example of Table 2, it is described that a maximum transmission power of a normal max power may be continuously usable during 50 seconds and backoff to a backoff max power is needed after 50 seconds. For example, it is assumed that an RF signal is transmitted at 23 dBm which is a normal max power during 50 seconds, and an RF signal is transmitted at 23 dBm which is a normal max power during a next P (0.5 seconds), and an RF signal is transmitted at 20 dBm which is a backoff max power during 49.5 seconds corresponding to (remain time−P). In this instance, a Tx room may be 150 mW/g−50×2 mW/g, and thus may be 50 mW/g. An SAR occurring during a P time may be 2 mW/g×0.5, and thus may be 1 mW/g. An SAR occurring during (remain time−P) may be 49.5 seconds×1 mW/g, and thus may be 49.5 mW/g. In this instance, a cumulative SAR during P and (remain time−P) may be 50.5 mW/g, and may exceed the Tx room. Therefore, it is identified that backoff of the maximum value of the transmission power at the time point P is required. The above-described example will be described with reference to FIG. 3B that describes a transmission power associated with one RAT. For example, referring to FIG. 3B, it is identified that a maximum transmission power may be configured to a normal max power 351 up to A seconds (e.g., 50 seconds), but it is identified that it is backed off to a backoff max power 352 after A seconds. As the maximum value of the maximum transmission power is backed off, a slope of a second part 362 of the cumulative SAR may be formed to be lower than a slope of a first part 361 of the cumulative SAR. It is identified that an average SAR 331 from A seconds ago exceeds an average SAR limit 340 but an average SAR 332 at a time point at which a time reaches 100 seconds is identical to a value of the average SAR limit 340 due to backoff. Here, 100 seconds is provided as an example, and for example, it may be a length of a time window corresponding to a frequency band less than or equal to 3 GHZ. Depending on implementation, the length of a time window for each frequency band may be configured to be different from each other. For example, a time window in FR1, which is greater than or equal to 3 GHZ, may be configured to 60 seconds and a time window in FR2 may be configured to 6 seconds, but these are merely examples. There may be a case in which the electronic device 101 performs transmission of RF signals for two or more radio access technologies (RATs), which will be described later. For example, the electronic device 101 may transmit a first RF signal based on evolved universal terrestrial radio access (E-UTRA) and a second RF signal based on NR, according to evolved universal terrestrial radio access network (E-UTRAN) new radio dual connectivity (EN-DC). In this instance, the electronic device 101 may back off a maximum value of a transmission power of an RF signal so that a cumulative SAR does not exceed a cumulative max SAR. The electronic device 101 may configure priorities of RATs for backoff. For example, the electronic device 101 may be configured to preferentially back off a transmission power of an RF signal based on NR that is RAT corresponding to a secondary cell group (SCG) than E-UTRA that is RAT corresponding to a master cell group (MCG). EN-DC is merely an example, and in the case of NE-DC, the electronic device 101 may be configured to preferentially back off a maximum value of a transmission power of an RF signal based on E-UTRA. Preferential backoff of a maximum value of a transmission power of an RF signal based on an SCG in DC is also an example, and the priority order for backoff is not limited.

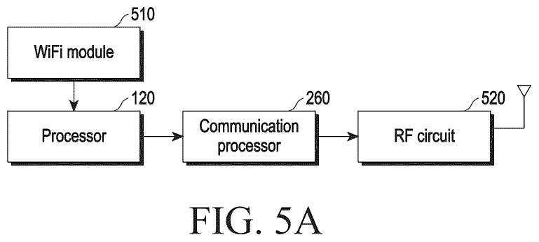

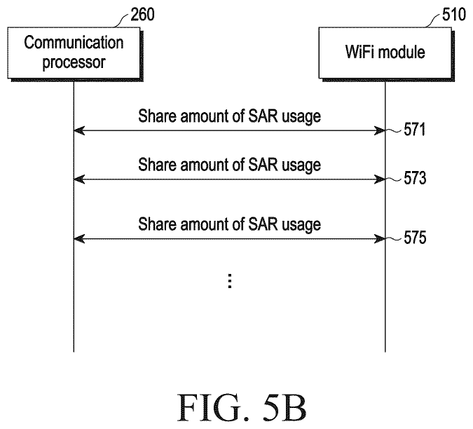

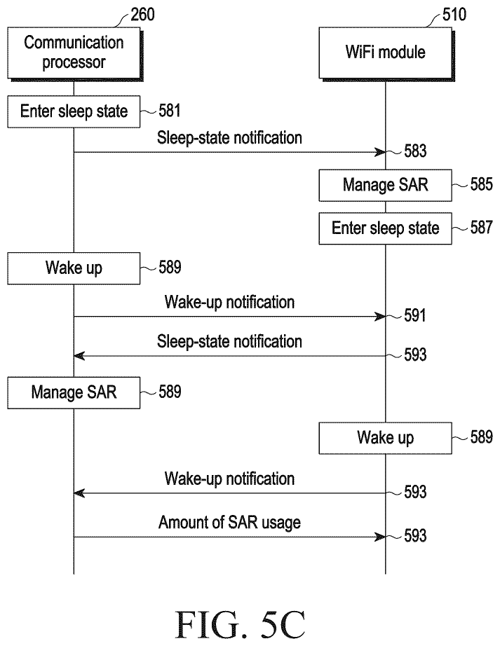

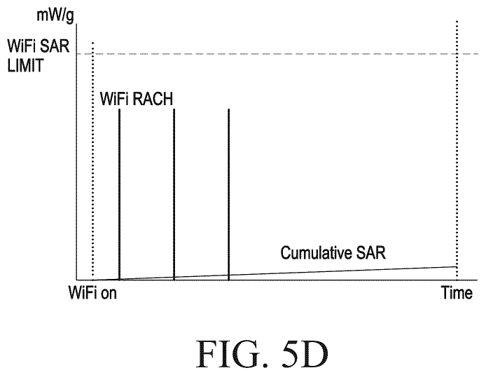

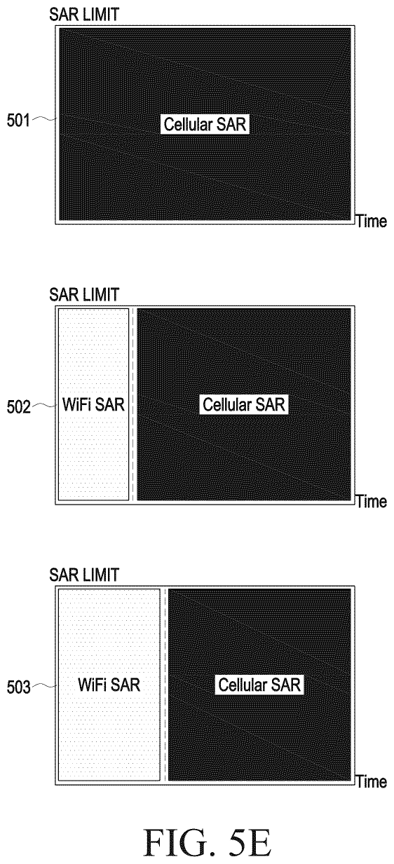

FIG. 5A is a block diagram of an electronic device including a WiFi module according to an embodiment of the disclosure.

Referring to FIG. 5A, WiFi communication and cellular communication may be performed via the processor 120 to which a WiFi module 510 is connected and the communication processor 260. The communication processor 260 of FIG. 5A may be replaced with the first communication processor 212 and/or the second communication processor 214. For example, in an electronic device, at least one of the WiFi communication and cellular communication may operate based on a time average SAR (TAS). For example, with respect to both the WiFi communication and cellular communication, a maximum SAR may be assigned as a fixed value. The maximum SAR may be an SAR value assigned to a time window of a predetermined length, and the value is not limited.

Parameters and units as shown in Table 3 are presented in order to describe a TAS operation in an electronic device according to an embodiment of the disclosure. For example, T is a time scale for an SAR average and may be, for example, 100 seconds(s). P is a period for calculating an average SAR, and may be, for example, 0.5 seconds. For example, a cumulative SAR limit may be a maximum SAR value that is capable of being used during T seconds. For example, a normal max power may denote a maximum value of a transmission strength. For example, in the electronic device, when a normal max power is changed to a backoff max power due to an insufficient SAR margin, power may be reduced as shown in graph 352 of FIG. 3B. For example, referring to FIG. 3B, when power is changed to the backoff max power, a slope of a graph of a cumulative SAR is also decreased and operation may be performed so that the cumulative SAR does not exceed a cumulative SAR limit during an average time.

TABLE 3
1. Parameter Definitions
Average Time (T): 100 seconds [Description: a time used for an average of SARs]
Calculator Period (P): 0.5 seconds [Description: a cycle for calculating an SAR]
RF exposure slot: magnitudes of an SAR and a PD used during a calculator period
RF exposure amount Table: a table for a sum of magnitudes of SARs and PDs from a
seconds to a + average time. For example, when the current time is a + 30 seconds, the
RF exposure amount table that starts from a seconds stores a total sum of RF exposure
slots in the range of a seconds to a + 30 seconds.
Number of RF exposure amount Tables: 199 [Description: having T/P − 1 calculator
tables]
SAR Limit: a maximum value that an SAR is limited to during 1 second ex) 1.6 mw/g
SAR Limit Power: Tx Power corresponding to SAR limit, ex) Tx power that exposures
an SAR of 1.6 mW/g, 22 dBm. The value may vary depending on an SAR event, tech,
or band.
Cumulative SAR Limit: 160 mW/g
Normal Max power: 24 dBm
Normal Max Power SAR usage of 2 mW/g*sec
backoff Max power: 21 dBm
backoff Max Power SAR usage of 1 mW/g*sec
Cumulative SAR Value = the amount of SAR accumulated up to the present in each table
2. Time Average SAR Equation
Cumulative SAR Value + Normal MAX SAR + (Backoff MAX BACKOFF SAR *
(Remain Time − P)/P) > Cumulative SAR LIMIT
3. Power Density (PD) and SAR Conversion
Cumulative PD/Cumulative Max PD <=1
Remaining PD Margin/Cumulative Max PD = a
SAR Margin/Cumulative Max SAR = a
SAR Margin = a × Cumulative Max SAR.

In the case of an electronic device according to an embodiment of the disclosure, antennas that perform cellular and WiFi communication may be located close to each other, and may be located in the same antenna group. In this instance, when performing communication, the electronic device may add an SAR consumed for each communication. For example, in the case of the electronic device, at least one of cellular communication and WiFi communication may operate based on a TAS as described above. In addition, although one of the two communication bands does not operate based on a TAS, the electronic device of the disclosure may calculate a magnitude of an SAR consumed during the past and a margin that remains while operation is performed based on the TAS. According to Table 3, although one of the two communication bands does not operate based on a TAS, and corresponds to a predetermined communication band (tech/band) of the electronic device that has a max power of S1 of FIG. 4D, the electronic device may store a magnitude of SAR usage during a past D1, and may calculate a remaining SAR margin. In addition, when one of the two communication bands operates based on a TAS, and an SAR margin may be transferred only from a communication band that does not operate based on a TAS to a communication band that operates based on a TAS.

FIG. 5B is a flowchart illustrating an operation of a WiFi module and a communication processor according to an embodiment of the disclosure.

Referring to FIG. 5B, according to an embodiment of the disclosure, the communication processor 260 may perform data transmission or reception with the WiFi module 510. As illustrated in FIG. 5A, the communication processor 260 may perform data transmission or reception with the WiFi module 510 via the processor 120, or may directly perform data transmission or reception. According to an embodiment of the disclosure, the communication processor 260 and the WiFi module 510 may perform data transmission or reception with an interface. Alternatively, according to an embodiment of the disclosure, the communication processor 260 and the WiFi module 510 may perform data transmission or reception by using shared memory. For example, any one entity may write predetermined information (e.g., a cumulative consumed SAR value and/or whether the cumulative consumed SAR value exceeds a threshold value) in the shared memory, and the other entity may read the corresponding information from the shared memory.

According to an embodiment of the disclosure, when both the communication processor 260 and the WiFi module 510 are in a wake-up state, any one of both entities may operate as a main device. Here, the main device may be an entity capable of assigning an SAR margin. In one example, the communication processor 260 may operate as a main device, but this is not limited thereto. When both entities 260 and 510 are in a wake-up state, the amount of SAR usage may be shared periodically (e.g., one second but not limited thereto) in operations 571, 573, and 575 as illustrated in FIG. 5B. In one example, the amount of SAR usage may be a cumulative value of SARs occurring during a designated period. Alternatively, the amount of SAR usage may be information indicating whether a cumulative value of SARs occurring during a designated period exceeds a threshold value. An entity (e.g., the communication processor 260) that operates as a main device may control SAR allocation based on the amount of SAR usage. For example, when the communication processor 260 is configured as a main device, the communication processor 260 may assign an SAR margin to each of cellular communication and WiFi communication, based on a cumulative value of SARs corresponding to the cellular communication and a cumulative value of SARs corresponding to the WiFi communication. Alternatively, the communication processor 260 may receive information associated with whether the cumulative value of SARs corresponding to the WiFi communication exceeds the threshold value, and may assign, based on the received information, an SAR margin to each of the cellular communication and WiFi communication. Those skilled in the art may understand that the above-described operation may be performed by the WiFi module 510 when the WiFi module 510 is configured as a main device.

FIG. 5C is a flowchart illustrating operation of a WiFi module and a communication processor according to an embodiment of the disclosure.

Referring to FIG. 5C, according to an embodiment of the disclosure, the communication processor 260 may perform data transmission or reception with the WiFi module 510. Referring to FIG. 5A, the communication processor 260 may perform data transmission or reception with the WiFi module 510 via the processor 120, or may directly perform data transmission or reception. When any one of the entities enters a sleep state, an entity that maintains a wake-up state may operate as a main device. For example, it is assumed that the communication processor 260 operates as a main device, and then enters a sleep state in operation 581. The communication processor 260 may provide a sleep-state notification to the WiFi module 510 in operation 583. The sleep-state notification may include information indicating entry to a sleep state, and may additionally include information associated with a cumulative SAR value. Although FIG. 5C illustrates that entry to the sleep state is performed in operation 581, and the sleep-state notification is provided in operation 583, those skilled in the art may understand that the order of both operations is not limited thereto. The WiFi module 510 may operate as a secondary device, and then may operate as a main device based on reception of the sleep-state notification. The WiFi module 510 may perform SAR management in operation 585 as at least part of the operation of the main device. The WiFi module 510, for example, may perform SAR management based on a cumulative SAR value consumed by cellular communication, which is included in the sleep-state notification or received separately from the sleep-state notification.

The WiFi module 510, for example, may enter a sleep state in operation 587. When the communication processor 260 is still in the sleep state at the time point at which operation 587 is performed, the WiFi module 501 may hold transmission of a sleep-state notification. This is merely an example, the WiFi module 501 may be configured to transmit a sleep-state notification. Subsequently, the communication processor 260 may perform wake-up in operation 589. Based on the wake-up, the communication processor 260 may provide a walk-up notification to the WiFi module 510 in operation 591. Based on reception of the wake-up notification from the communication processor 260, the WiFi module 510 may transmit the sleep-state notification that the WiFi module 510 has been holding, in operation 593. Based on reception of the sleep-state notification, the communication processor 260 may operate as a main device. Although the sleep-state notification may include a cumulative SAR value consumed by the WiFi communication, this is merely an example. The cumulative value of consumed SARs may be provided to the communication processor 260 separately from the sleep-state notification. When the WiFi module 510 is in a wake-up state, the cumulative value of consumed SARs may be provided immediately, and when the WiFi module 510 is in a sleep-state, it may temporarily wake up and provide the cumulative value of consumed SARs, and then may enter the sleep state again. As described above, the communication processor 260 and the WiFi module 510 may perform data transmission or reception by using shared memory. For example, one entity may write, in the shared memory, a sleep state notification and/or wake-up notification, and/or information associated with a cumulative value of consumed SARs, and the other entity may read the same. The communication processor 260 and the WiFi module 510 may use both the shared memory and interface. For example, configuration may be performed so that one entity provides information using shared memory when a counterpart entity is in a sleep state, and provides information via an interface when the counterpart entity is in a wake-up state.

FIG. 5D is a diagram illustrating an SAR that WiFi uses when performing a RACH operation, according to a comparative example for comparison according to an embodiment of the disclosure.

Referring to FIG. 5D, when WiFi communication is turned on in the state in which an electronic device according to an embodiment of the disclosure is connected with cellular communication, the cellular communication may regard that WiFi is to use an overall SAR assigned to WiFi. More particularly, when a connection condition is poor and only RACH is performed, although WiFi is on, or when a connection is established but data transmission is not substantially performed since an electric field is significantly weak, the amount of SAR usage of cellular may become significantly small. Referring to FIG. 5D, it is identified that a WiFi SAR limit is maintained as a high value continuously after WiFi is on although a cumulative SAR for WiFi is increased at a significantly low rate. In this instance, WiFi communication may be incapable of using all the SAR margin assigned to WiFi, and this may cause a waste of SAR margin. When an SAR margin is wasted in the WiFi communication, the cellular communication may not use the same even though an unconsumed SAR margin is available, and thus there is the probability of causing an unnecessary backoff for the cellular communication.

For example, the fact that a large portion of the SAR is assigned to WiFi indicates that the SAR usage of the cellular communication may be significantly reduced for WiFi. In this instance, the electronic device may need to perform backoff earlier when using cellular communication. In other words, in the electronic device, backoff may occur in the cellular communication due to the margin assigned to WiFi and not used.

FIG. 5E is a diagram 501 illustrating a magnitude of an SAR margin for each communication according to an embodiment of the disclosure.

Referring to FIG. 5E, illustrates a total amount of SAR when an electronic device (e.g., the electronic device 101 of FIGS. 1, 2A, and 2B) uses cellular and WiFi communication during a time interval. For example, the cellular communication may use 100% of the SAR. For example, when WiFi communication is not activated (e.g., when the WiFi module 510 is turned off), an SAR margin may not need to be assigned to the WiFi communication and thus, the overall SAR may be assigned to the cellular communication to the maximum extent. For example, referring to diagram 503 of FIG. 5E, since the total amount of SAR is determined, when WiFi communication is needed in the state in which the cellular communication is used, a predetermined amount of WiFi SAR may be assigned. For example, if it is configured to assign 30% when the WiFi communication is on, 70% may be assigned to the cellular communication. However, as illustrated in FIG. 5D, SAR consumption by the WiFi communication may be relatively small. In this instance, there may be the probability of wasting an SAR margin assigned to the WiFi communication. Accordingly, the electronic device according to an embodiment may gradually assign an SAR margin to the WiFi communication. The electronic device may not assign a 30% SAR margin from the time point when activation of the WiFi communication is identified, as shown in diagram 503, but may assign, for example, a relatively small SAR margin (e.g., 10%) to the WiFi communication at first as shown in diagram 502. Referring to diagram 502 of FIG. 5E, an SAR portion for the cellular communication may be sufficiently secured by adjusting an SAR portion for WiFi according to the situation. For example, when the WiFi communication only performs a RACH operation or when data communication is not smoothly performed, it is adjusted to assign a 10% SAR for the WiFi communication and to assign 90% for the cellular communication. Subsequently, when it is identified that a relatively large SAR portion is consumed by the WiFi communication, the electronic device may adjust an SAR margin to be assigned to the WiFi communication to be relatively large (e.g., 30%) as shown in diagram 503.

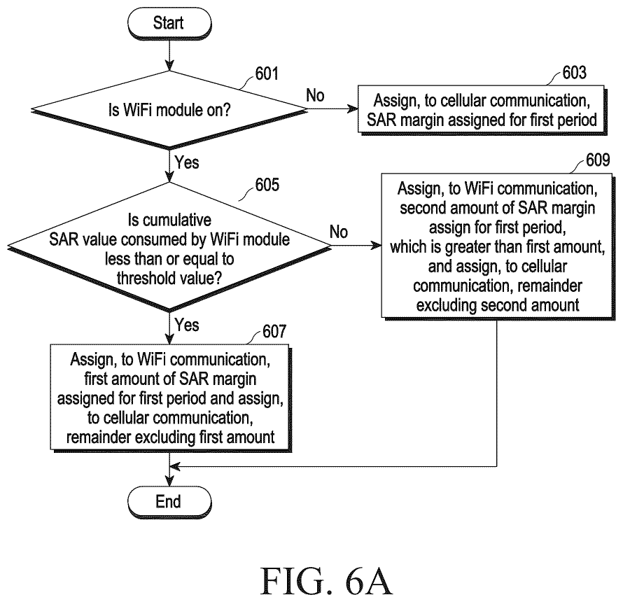

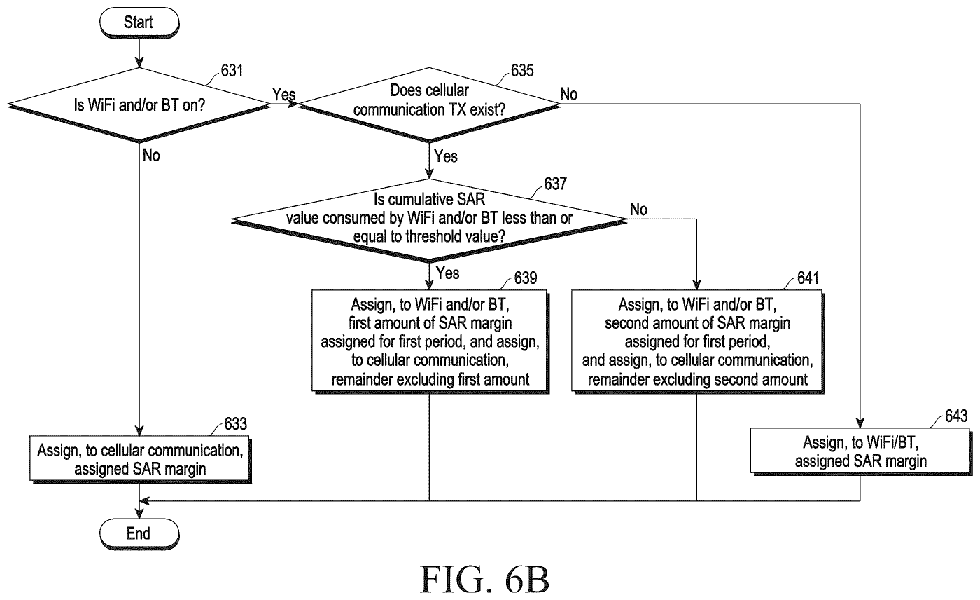

FIG. 6A is a diagram illustrating an operation of assigning a magnitude of an SAR margin for WiFi communication according to an embodiment of the disclosure.

An electronic device according to an embodiment of the disclosure may gradually adjust a WiFi SAR margin when the amount of SAR usage of the WiFi communication exceeds a predetermined threshold value.

Referring to FIG. 6A, in operation 601, the electronic device (e.g., electronic device 101 of FIGS. 1, 2A, and 2B) may identify whether a WiFi module is on while operating in cellular communication. For example, the processor 120 of FIG. 5A may identify whether the WiFi module 510 is activated. The processor 120 may provide, to the communication processor 260, information associated with whether the WiFi module 510 is activated. Based on changing from the active state of the WiFi module 501, the processor 120 may provide, to the communication processor 260, information associated with the active state of the WiFi module 501, but the time point for the provision and/or a trigger for provision is not limited. Although not illustrated in FIG. 5A, the communication processor 260 may directly receive the information associated with the active state of the WiFi module 501 from the WiFi module 510, and a method by which the communication processor 260 obtains information associated with the active state of the WiFi module 501 is not limited.

In operation 603 of FIG. 6A, when the electronic device determines that WiFi communication is not initiated (No in operation 601), the electronic device may assign the cellular communication (e.g., 100% cellular) an SAR margin that is assigned to at least one antenna group during a predetermined period (e.g., first period). Although FIG. 6A describes an example in which only cellular communication and WiFi communication are included in one antenna group, those skilled in the art may understand that additional communication scheme may be included in the corresponding antenna group. For example, Bluetooth communication, in addition to the cellular communication and WiFi communication, may be included in one antenna group. For example, distances between two of a cellular communication-based antenna, a WiFi communication-based antenna, and a Bluetooth communication-based antenna may be less than a threshold distance, and thus three communications may be included in one antenna group. In this instance, an SAR assigned to one antenna group need to be assigned to the Bluetooth communication in addition to the cellular communication and the WiFi communication so that a Bluetooth communication-based RF signal may be emitted. In this instance, those skilled in the art may understand that operation 603 assigns the cellular communication the overall SAR assigned to the antenna group when the Bluetooth communication is deactivated, and assigns the cellular communication the remainder excluding an amount assigned to the Bluetooth communication from the overall SAR assigned to the antenna group when the Bluetooth communication is activated.

When the electronic device determines that WiFi communication is initiated (Yes in operation 601), the electronic device may identify that a WiFi module is on in operation 605 of FIG. 6A, and identify whether a cumulative SAR value consumed by the WiFi module is less than or equal to a threshold value.

In operation 607 of FIG. 6A, when the electronic device identifies that the cumulative SAR value consumed by the WiFi module is less than or equal to the threshold value (Yes in operation 605), the electronic device may assign the WiFi communication a first amount (e.g., 10% of the total SAR margin) of the SAR margin assigned for the first period, and may assign the cellular communication a remaining amount (e.g., 90% of the total SAR margin) excluding the first amount. For example, the electronic device may not assign the WiFi communication an SAR margin immediately after identifying that the WiFi module is on, but may increase a WiFi SAR margin when SAR usage of the WiFi communication reaches a predetermined threshold value. For example, in the case in which the total SAR margin that the electronic device is capable of using is 100, when the WiFi communication is initiated during cellular communication, the usage does not exceed a predetermined threshold value, and thus 10 of the total SAR margin may be assigned to the WiFi communication and 90 may be assigned to the cellular communication.

In operation 609 of FIG. 6A, when the electronic device identifies that the cumulative SAR value consumed by the WiFi module exceeds the threshold value (No in operation 605), the electronic device may assign the WiFi communication a second amount (e.g., 30% of the total SAR margin) of the SAR margin assigned for the first period, which is greater than the first amount, and may assign the cellular communication a remaining amount (e.g., 70% of the total SAR margin) excluding the second amount. For example, the electronic device may identify that the WiFi module is on, and may identify whether SAR usage of the WiFi communication exceeds a threshold value. In this instance, the electronic device may identify a cumulative amount of SAR usage of the WiFi communication, and may increase an SAR margin to be assigned to WiFi. For example, in the case in which the total SAR margin that the electronic device is capable of using is 100, when the WiFi communication is performed during cellular communication, the electronic device may identify a cumulative amount of SAR usage of the WiFi communication and may assign 30 to the WiFi communication and may assign 70 to the cellular communication.

FIG. 6B is a flowchart illustrating an operation method of an electronic device according to an embodiment of the disclosure.

Referring to FIG. 6B, according to an embodiment of the disclosure, the electronic device may identify whether a WiFi module and/or Bluetooth module is turned on (or in an active state) in operation 631. When the WiFi module and/or Bluetooth module is not turned on (or not in an active state) (No in operation 631), the electronic device may assign cellular communication an SAR margin assigned to one antenna group in operation 633. When the WiFi module and/or Bluetooth module is turned on (or in an active state) (Yes in operation 631), the electronic device may identify whether cellular communication-based transmission data exists in operation 635. Alternatively, the electronic device may identify whether a cellular communication-based antenna is included in the corresponding antenna group. When the cellular communication-based transmission data does not exist (No in operation 635), the electronic device may assign the assigned SAR margin to the WiFi communication and/or Bluetooth communication in operation 643. When the cellular communication-based transmission data exists (Yes in operation 635), the electronic device may identify whether a cumulative SAR value consumed by the WiFi module and/or Bluetooth module is less than or equal to a threshold value in operation 637. When the cumulative SAR value consumed by the WiFi module and/or Bluetooth module is less than or equal to the threshold value (Yes in operation 637), the electronic device may assign the WiFi communication and/or Bluetooth communication a first amount of the SAR margin assigned for a first period and assign the cellular communication the remainder excluding the first amount in operation 639. When the cumulative SAR value consumed by the WiFi module and/or Bluetooth module exceeds the threshold value (No in operation 637), the electronic device may assign the WiFi communication and/or Bluetooth communication a second amount of the SAR margin assigned for the first period, which is greater than the first amount, and assign the cellular communication the remainder excluding the second amount in operation 641.

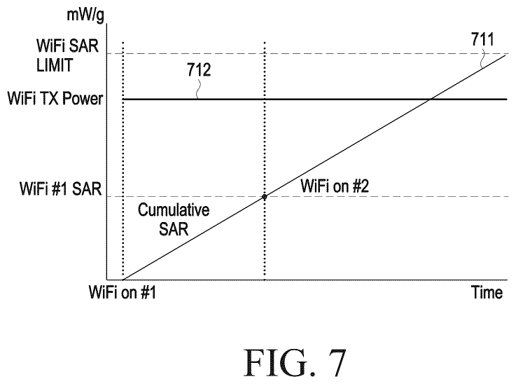

FIG. 7 is a diagram illustrating a cumulative SAR as an SAR margin for WiFi communication is assigned according to an embodiment of the disclosure.

Referring to FIG. 7, an electronic device according to an embodiment of the disclosure may operate a WiFi operation without backoff as an SAR margin for WiFi communication changes. Although FIG. 7 describes the Wifi communication, those skilled in the art may understand that the WiFi communication in the embodiment and other embodiments may be replaced with WiFi communication and/or Bluetooth communication. FIG. 7 illustrates a cumulative SAR amount 711 when a WiFi module is on and the electronic device performs WiFi communication at a predetermined power 712. For example, since the cumulative amount of SAR usage 711 does not exceed a threshold value when WiFi is on (e.g., WiFi ON #1 of FIG. 7), the electronic device may configure an SAR margin to a first amount (e.g., 607 of FIG. 6A) (e.g., WiFi #1 SAR of FIG. 7). At the time point (e.g., WiFi On #2) at which the cumulative SAR value consumed by the WiFi communication exceeds the threshold value, the electronic device may increase a WiFi SAR margin from the first amount (e.g., 607 of FIG. 6A) (e.g., WiFi #1 SAR of FIG. 7) to a WiFi SAR limit (e.g., second amount described in FIG. 6A). Accordingly, although a maximum value 721 of a transmission power of Wifi is not backed off, a TAS in WiFi may not fail.

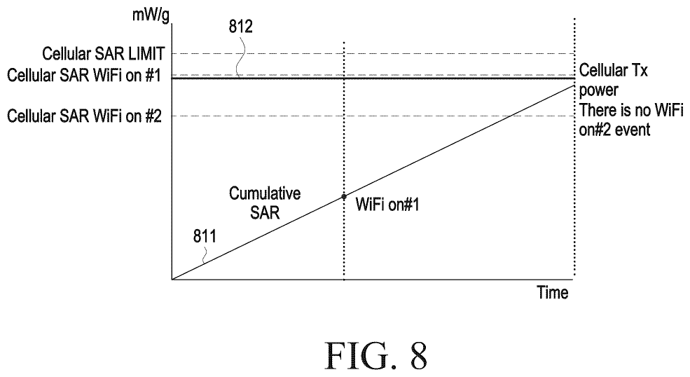

FIG. 8 is a diagram illustrating a cumulative SAR of cellular communication as an SAR margin for WiFi communication changes according to an embodiment of the disclosure.

Referring to FIG. 8, an electronic device according to an embodiment of the disclosure may operate an effective cellular communication operation as an SAR margin for WiFi communication changes. For example, when SAR usage of WiFi is not greater than or equal to a threshold value, the electronic device may continuously perform communication in the cellular communication without backing off a maximum value 812 of a transmission power of the cellular communication. For example, referring to FIG. 8, the electronic device of the disclosure may perform cellular communication at Cellular Tx Power in a first time interval. Referring to FIG. 8, the WiFi communication may be initiated (Yes in operation 601 of FIG. 6A) (e.g., WiFi ON #1 of FIG. 8) while cellular communication is performed. In this instance, the electronic device was capable of assigning the cellular communication the overall SAR margin assigned for a first period (or the remainder excluding the amount of SAR assigned to another communication scheme (e.g., Bluetooth (BT)) from the SAR margin), and thus an initial SAR limit of the cellular communication may be Cellular SAR LIMIT (e.g., 603 of FIG. 6A) of FIG. 8. For example, when the WiFi communication is on (e.g., Yes in operation 601 of FIG. 6A), the electronic device may assign a first amount as a WiFi SAR margin as shown in FIG. 6A, and thus a cellular SAR margin may be decreased from Cellular SAR LIMIT to Cellular SAR WiFi ON #1 (e.g., 607 of FIG. 6A) as shown in FIG. 8. Although the electronic device decreases a portion of the SAR margin for the cellular communication, a cumulative amount of SAR usage 811 is low, and thus the maximum value 812 of the transmission power may not be backed off. A Wifi ON #2 event, for example, an event with cumulative SAR usage greater than or equal to a threshold value corresponding to the Wifi communication, is not detected, and thus the electronic device may assign the cellular communication a relatively large (e.g., 90%) SAR margin, and since the relatively large SAR margin is assigned to the cellular communication, the maximum value 812 of the transmission power corresponding to the cellular communication may not be backed off.

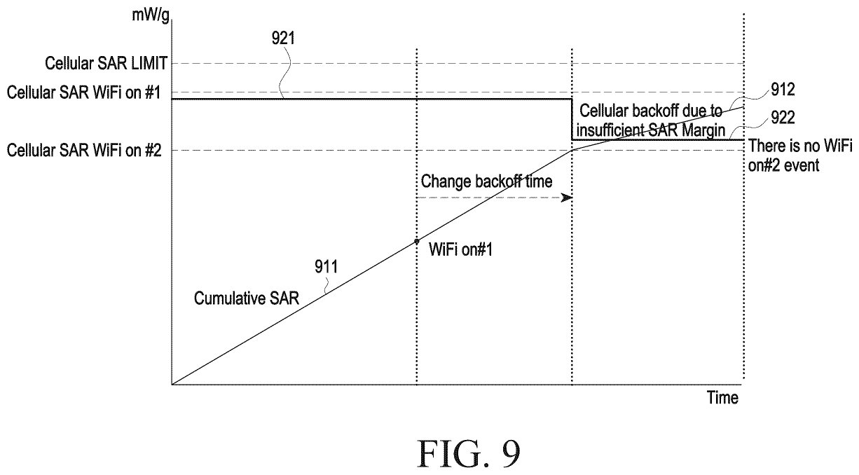

FIG. 9 illustrates a case in which a transmission power of cellular communication is configured to be greater than the case of FIG. 8 according to an embodiment of the disclosure.

Referring to FIG. 9, a maximum value 921 of a transmission power of cellular communication is greater than the maximum value 812 of the transmission power of FIG. 8, and thus a slope of a graph of a cumulative SAR 911 is greater than a slope of the graph of the cumulative SAR 811 of FIG. 8. In the example of FIG. 9, it is assumed that a Wifi ON #2 event, for example, an event with SAR usage of the Wifi communication greater than or equal to a threshold value, is not detected. In the case of a Wifi ON #1 event, for example, when the WiFi module 510 is activated, an electronic device may assign an SAR margin of a first value (e.g., 10%) to the WiFi module 510, and may assign the remainder (e.g., 90%) to the cellular communication. The remainder (e.g., 90%) may be Cellular SAR Wifi ON #1 of FIG. 9. Cellular SAR Wifi ON #2 of FIG. 9 may be an SAR margin (e.g., 70%) when the Wifi ON #2 event, for example, an event with SAR usage of the Wifi communication greater than or equal to the threshold value, is detected. If an SAR margin (e.g., 70%) when the Wifi ON #2 event, for example, an event with SAR usage of the Wifi communication greater than or equal to the threshold value, is detected is merely assigned to the cellular communication from the time point at which the Wifi ON #1 event, for example, the activation of the WiFi module 510, is initially detected, the maximum value of the transmission power corresponding to the cellular communication may be backed off relatively earlier. However, Cellular SAR Wifi ON #1 is assigned to the cellular communication at the time point at which the Wifi ON #1 event, for example, the activation of the WiFi module 510 is initially detected, and thus the time point of backoff of the maximum value of the transmission power corresponding to the cellular communication may be delayed. For example, in FIG. 9, at the time point of cellular backoff due to an insufficient SAR margin, a maximum value 922 of the transmission power corresponding to the cellular communication may be backed off from the existing maximum value 921. Due to the backoff, a slope of a graph of a cumulative SAR 912 may be decreased to be lower than the slope of the graph of the existing cumulative SAR 911. If an SAR margin (e.g., 70%) when the Wifi ON #2 event, for example, an event with SAR usage of the Wifi communication greater than or equal to the threshold value is detected is merely assigned to the cellular communication from the time point at which the Wifi ON #1 event, for example, the activation of the WiFi module 510, is detected initially, the maximum value of the transmission power corresponding to the cellular communication may be backed off relatively earlier. However, Cellular SAR Wifi ON #1 is assigned to the cellular communication at the time point at which the Wifi ON #1 event, for example, the activation of the WiFi module 510 is initially detected, and thus the time point of backoff of the maximum value of the transmission power corresponding to the cellular communication may be delayed.

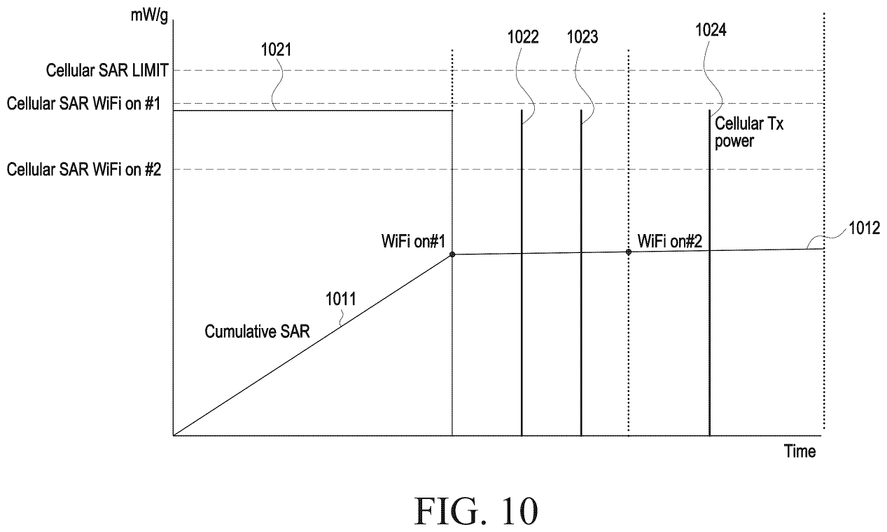

FIG. 10 is a diagram illustrating a cumulative SAR of cellular communication as an SAR margin for WiFi communication changes according to an embodiment of the disclosure.

Referring to FIG. 10, an electronic device according to an embodiment of the disclosure may continuously use cellular communication, for example, until a WIFI ON #1 event occurs, and a cumulative SAR 1011 may be increased. As the WiFi ON #1 event occurs, an SAR margin of the cellular communication may be decreased to Cellular SAR WiFi ON #1 (e.g., 90%). Cellular SAR Wifi ON #2 of FIG. 10 may be an SAR margin (e.g., 70%) when a Wifi ON #2 event, for example, an event with SAR usage of the Wifi communication greater than or equal to a threshold value, is detected. If an SAR margin (e.g., 70%) when the Wifi ON #2 event, for example, an event with SAR usage of the Wifi communication greater than or equal to the threshold value, is detected is merely assigned to the cellular communication, a maximum value of a transmission power corresponding to the cellular communication may be backed off relatively earlier. However, there may be a situation in which the electronic device intermittently transmits a signal after the time point of WiFi ON #1, for example, the electronic device may use a cellular transmission power (Cellular Tx power) only at a predetermined time point. Referring to FIG. 10, a maximum value 1021 of the transmission power of the cellular communication is continuous before WiFi ON #1, but subsequent maximum values 1022, 1023, and 1024 are identified as being discrete. In this instance, an increase of a cumulative SAR 1012 that the electronic device uses for the cellular communication is significantly low, and thus the electronic device may not need to perform a cellular backoff. According to an embodiment of the disclosure, although a cumulative amount of SAR usage in the WiFi communication exceeds the threshold value corresponding to the WiFi communication, when signal transmission in cellular does not exists, except for an IP multimedia subsystem (IMS) APN, since the Internet access point name (APN) is assigned to WiFi, SAR consumption by the cellular communication is significantly low even when a WiFi SAR margin is assigned according to an original configuration value (e.g., 30%), and thus a cellular backoff may not be needed when signal transmission intermittently occurs.

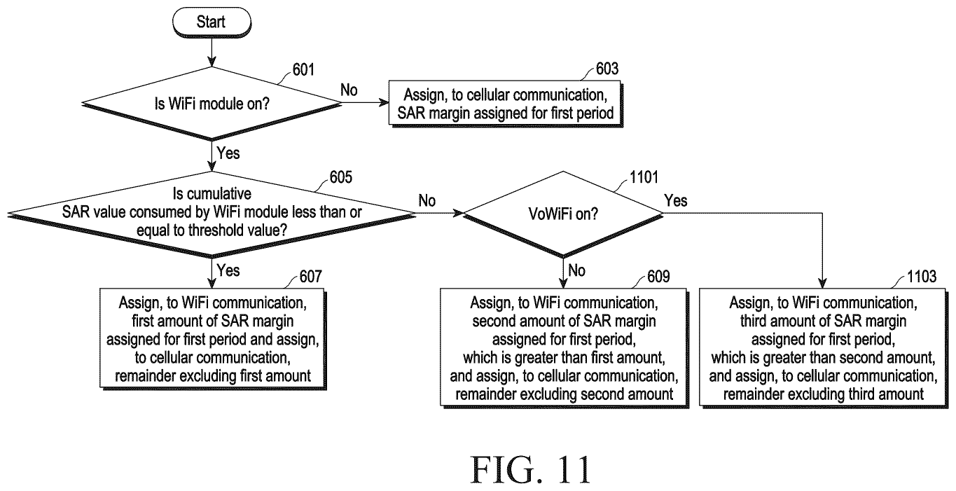

FIG. 11 is a diagram illustrating an operation of assigning a magnitude of an SAR margin when a voice call operation of WiFi communication is performed, according to an embodiment of the disclosure.

The description with reference to FIG. 6A may be applicable to operations 601, 603, and 605 of FIG. 11.

Referring to FIG. 11, in operation 1101, an electronic device of the disclosure may identify that a cumulative SAR value consumed by a WiFi module is not less than or equal to a threshold value (No in operation 605), and may identify whether VoWiFi operates (VoWiFi ON). The electronic device according to an embodiment of the disclosure may need to secure a sufficient WiFi SAR margin so that a WiFi SAR margin is not insufficient while VoWiFi operates. The electronic device of the disclosure may enable a VoWiFi voice call to be performed stably.

In operation 609, when the electronic device identifies that the cumulative SAR value consumed by the WiFi module exceeds the threshold value (No in operation 605) (e.g., WiFi ON #2 event of FIGS. 7 and 10), the electronic device may assign the WiFi communication a second amount (e.g., 30% of a total SAR margin) of an SAR margin assigned for a first period, which is greater than a first amount, and may assign cellular communication a remaining amount (e.g., 70% of the total SAR margin) excluding the second amount. In this instance, the electronic device may identify a cumulative amount of SAR usage of the WiFi communication, and may increase an SAR margin to be assigned to WiFi. For example, in the case in which the WiFi communication is initiated (Yes in operation 601) and the cumulative SAR value consumed by the WiFi communication exceeds the threshold value (No in operation 605), when a predetermined condition, such as operation of VoWiFi, is not satisfied, the electronic device of the disclosure may assign the WiFi communication the second amount of the SAR margin assigned for the first period (No in operation 1101) and may assign the cellular communication the remaining SAR margin.

In operation 1103, the electronic device according to an embodiment of the disclosure may assign the WiFi communication a third amount (e.g., 40% of the total SAR margin) of the SAR margin assigned for the first period, which is greater than the second amount, and may assign the cellular communication the remainder (e.g., 60% of the total SAR margin) excluding the third amount. For example, when initiation of the VoWiFi operation is identified (Yes in operation 1101), the electronic device may need to increase an SAR margin to be assigned to the WiFi communication. Therefore, the VoWiFi voice call operation may be stably maintained.

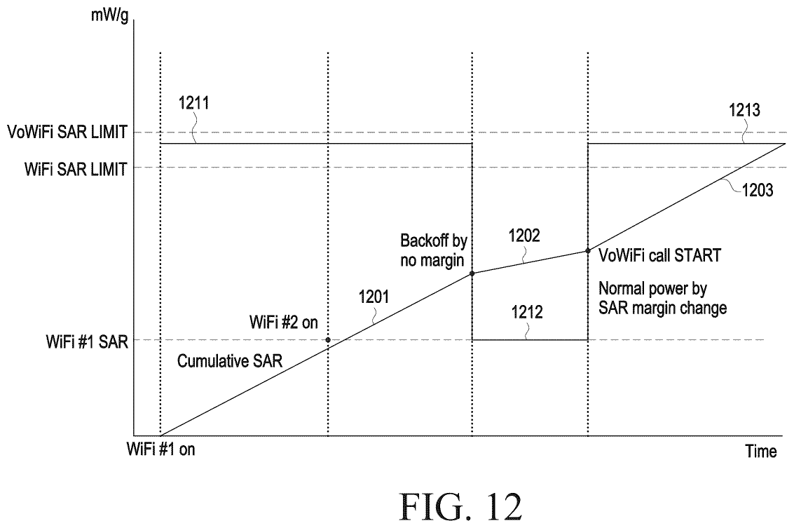

FIG. 12 is a diagram illustrating a cumulative SAR as a voice call operation of WiFi communication is performed according to an embodiment of the disclosure.

Referring to FIG. 12, it illustrates a cumulative amount of SAR usage 1201 of Wifi communication while a transmission power corresponding to the WiFi communication of the electronic device is a maximum value 1211. According to an embodiment of the disclosure, the WiFi communication may be initiated (e.g., the occurrence of a WiFi ON #1 event of FIG. 12 is identified) when the electronic device performs cellular communication. When the WiFi communication is initiated and the cumulative amount of SAR usage 1201 of the WiFi communication is identified as being less than or equal to a threshold value corresponding to the WiFi communication, the electronic device may configure an SAR margin (WiFi SAR LIMIT) of the WiFi communication to a first amount (WiFi #1 SAR) (e.g., 10%). When it is identified that the cumulative amount of SAR usage of the WiFi communication exceeds the threshold value (e.g., WiFi ON #2 event), the electronic device may increase the SAR margin of the WiFi communication to a second amount (e.g., 30%) (e.g., Wifi SAR LIMIT of FIG. 12), and may delay a backoff time. Referring to FIG. 12, backoff may be performed after the WiFi ON #2 event and it is identified that a maximum value 1212 of the transmission power of the WiFi communication is decreased. Accordingly, a slope of a cumulative SAR 1202 may be decreased to be lower than a slope of the existing cumulative SAR 1201. When the SAR margin of the WiFi is maintained as the second amount (e.g., 30%), the electronic device may have a difficulty in smoothly performing a VoWiFi voice call operation. In this instance, when it is identified that the VoWiFi voice call operation is initiated, the electronic device may increase the SAR margin of the WiFi to a third amount (e.g., 40%) (e.g., VoWiFi SAR LIMIT of FIG. 12). Accordingly, a maximum value 1213 of the transmission power of the WiFi may be restored and the VoWiFi may be stably operated. During this time, a cumulative SAR 1203 may have a slope higher than that of the existing cumulative SAR 1202, and the cumulative SAR 1203 may exceed the WiFi SAR LIMIT but may be less than or equal to VoWiFi SAR LIMIT.

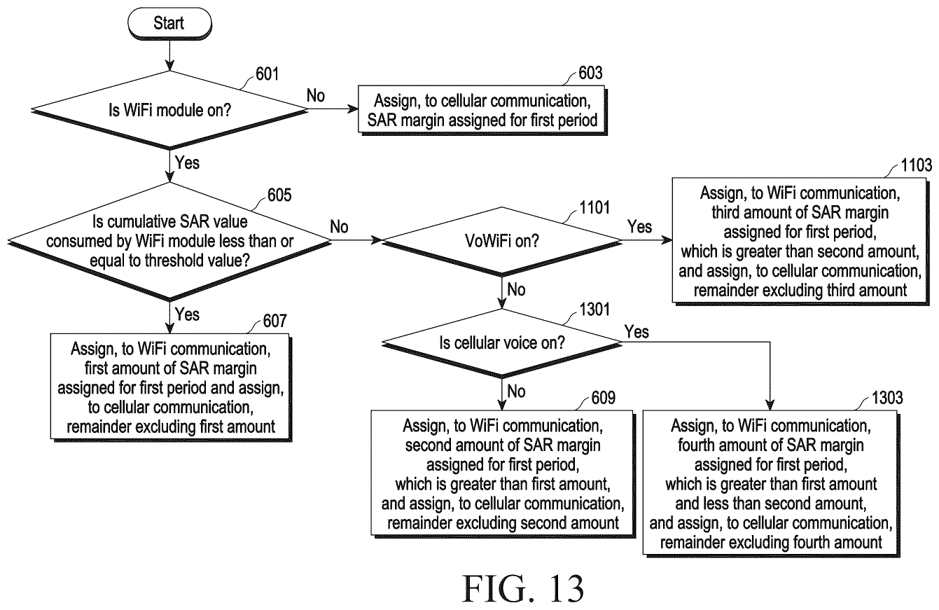

FIG. 13 is a diagram illustrating an operation of assigning a magnitude of an SAR margin when a voice call operation of cellular communication is performed while WiFi is connected, according to an embodiment of the disclosure.

FIG. 13 illustrates the case in which a WiFi voice call is initiated and VOLTE or VoNR operation is initiated.

The description with reference to FIG. 6A may be applicable to operations 601, 603, and 605 of FIG. 13.

The description with reference to FIG. 11 may be applicable to operations 1101 and 1103 of FIG. 13.

Referring to FIG. 13, in operation 1301, in the case in which a cumulative SAR value consumed by a WiFi module exceeds a threshold value (No in operation 605), when VoWiFi is not performed (No in operation 1101), the electronic device according to an embodiment of the disclosure may identify whether a cellular voice operation is initiated.

The electronic device according to an embodiment of the disclosure may need to secure a sufficient SAR margin of cellular communication so that an SAR margin of the cellular communication is not insufficient while a cellular voice operation is performed. The electronic device according to an embodiment of the disclosure may enable a cellular voice call to be operated stably.

In operation 609, when the electronic device identifies that the cumulative SAR value consumed by the WiFi module exceeds the threshold value (No in operation 605) and a WiFi voice call or cellular voice call operation is not performed (No in operation 1101, No in operation 1301), the electronic device may assign the WiFi communication a second amount (e.g., 30% of a total SAR margin) of an SAR margin assigned for a first period, which is greater than a first amount, and may assign the cellular communication a remaining amount (e.g., 70% of the total SAR margin) excluding the second amount.

In operation 1303, when the electronic device identifies that the cumulative SAR value consumed by the WiFi module exceeds the threshold value (No in operation 605), and identifies that a WiFi voice call operation is not performed (No in operation 1101) but a cellular voice call operation is performed (Yes in operation 1301), the electronic device may assign the WiFi communication a fourth amount (e.g., 20% of the total SAR margin) of the SAR margin assigned for the first period, which is greater than the first amount and less than the second amount, and may assign the cellular communication a remaining amount (e.g., 80% of the total SAR margin) excluding the fourth amount.

In the electronic device according to an embodiment of the disclosure, a cellular SAR may not be insufficient when a signal is continuously transmitted in WiFi communication in a WiFi connected state. In this instance, when a cellular voice call operation is initiated, the Internet APN is transferred via WiFi and a voice call transmits data in cellular, and thus the SAR margin of the cellular communication may be insufficient. According to an embodiment of the disclosure, when the electronic device identifies a cumulative amount of SAR usage in the cellular communication and determines that the cellular SAR margin is insufficient, the electronic device may not assign an SAR to WiFi or assign only a portion although WiFi requests an SAR, so as to increase an SAR margin to be assigned to the cellular communication. Therefore, when it is identified that a VOLTE or VoNR operation is initiated, the electronic device may increase the SAR margin of the cellular communication and stably maintain a voice call operation of the cellular communication.

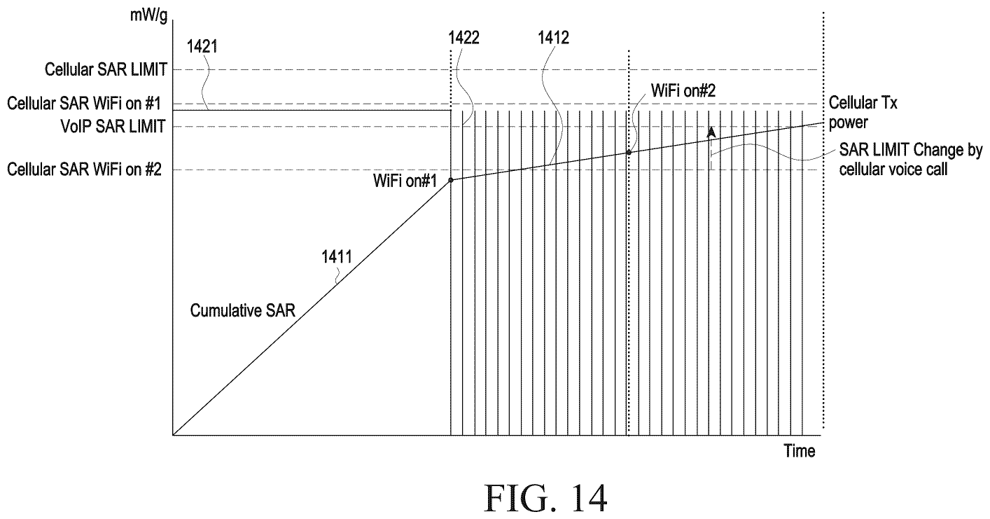

FIG. 14 is a diagram illustrating a cumulative SAR as a voice call operation of cellular communication is performed while WiFi is connected according to an embodiment of the disclosure.

Referring to FIG. 14, according to an embodiment of the disclosure, it illustrates a cumulative SAR 1411 when the electronic device initiates WiFi communication at the same time when performing cellular communication. For example, the cumulative SAR 1411 in the cellular communication of the electronic device may be increased while a transmission power corresponding to the cellular communication is a maximum value 1421. While a telephone service (e.g., VoIP service) via the cellular communication is performed, a maximum value 1422 of the transmission power may be expressed to be discrete as illustrated in FIG. 14. During this time, a cumulative SAR 1412 of the cellular communication may be increased but may have a slope lower than before. In order to perform a stable VOIP service, when it is determined that a cellular SAR margin is insufficient while a VOIP service is performed, the electronic device may increase an SAR margin (VOIP SAR LIMIT) to be assigned to the cellular communication. For example, even when it is identified that WiFi communication is initiated (WiFi ON #1 event) while cellular communication is performed and a cumulative amount of SAR usage of the WiFi communication exceeds a threshold value (WiFi ON #2 event), if it is identified that a VOLTE or VoNR operation (Cellular voice call) is initiated, the electronic device may increase the SAR margin (VOIP SAR LIMIT) of the cellular communication so as to stably maintain a transmission signal strength of the cellular communication.

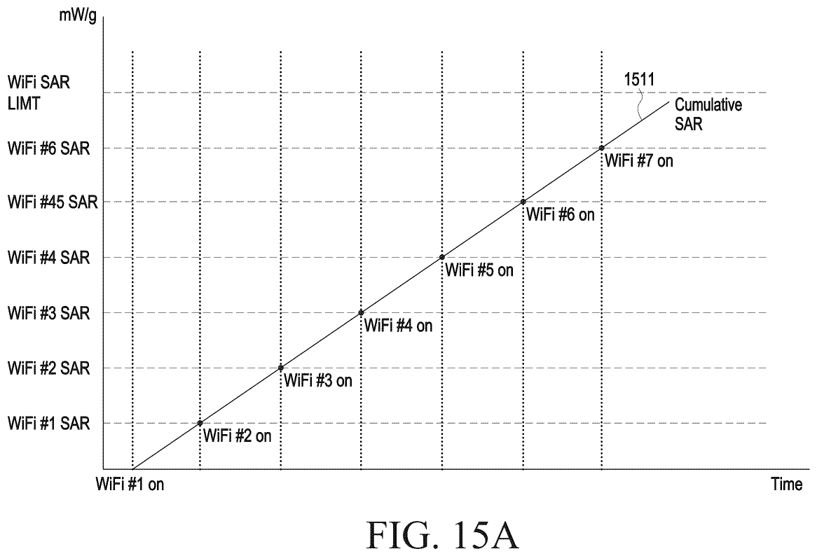

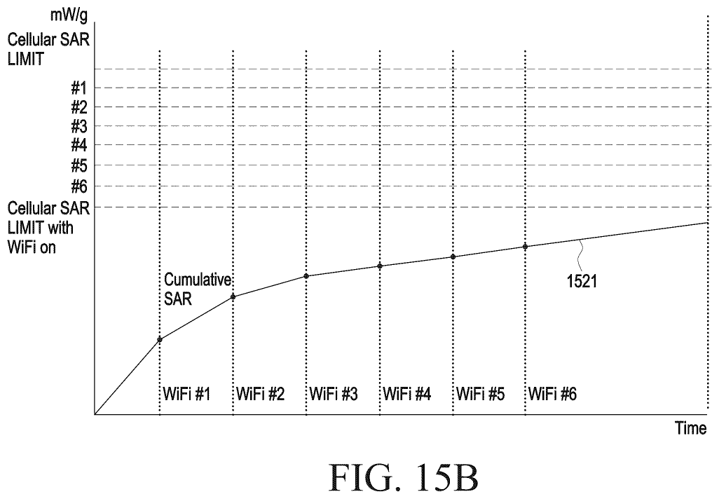

FIG. 15A is a diagram illustrating a cumulative SAR as a WiFi SAR margin is gradually increased according to an embodiment of the disclosure.

FIG. 15B is a diagram illustrating a cumulative SAR of cellular communication when a WiFi SAR margin is gradually increased according to an embodiment of the disclosure.

Referring to FIGS. 15A and 15B, an electronic device according to an embodiment of the disclosure may gradually increase or decrease an SAR margin of cellular and/or WiFi communication, and a cumulative SAR is illustrated by subdividing the process. For example, when WiFi needs to continuously transmit data, most data may be transmitted via WiFi and a cumulative SAR 1521 or instantaneous SAR consumed in cellular may not be high. In this instance, the electronic device may identify whether WiFi communication is initiated (identify whether a WiFi ON #1 event occurs), and may identify whether the amount of SAR margin usage of WiFi communication exceeds a first threshold value (identify whether a WiFi ON #2 event occurs), and when the usage exceeds the first threshold value, the electronic device may increase the SAR margin of the WiFi communication from a first amount (WiFi #1 SAR) to a second amount (WiFi #2 SAR). The electronic device may configure SAR margins for multiple WiFi communications, as shown in FIG. 15A. For example, when the amount of SAR margin usage of the WiFi communication exceeds a second threshold value that is greater than the first threshold, the electronic device may increase the SAR margin of WiFi from the second amount (WiFi #2 SAR) to a third amount (WiFi #3 SAR). In the same manner, when a cumulative SAR 1511 of WiFi is increased, the electronic device may identify a threshold value for the cumulative SAR 1511 n times. According to the disclosure, the electronic device may subdivide identifying of a threshold value for the cumulative SAR 1511 of the WiFi communication, and may distribute an SAR margin at an appropriate ratio according to an increase and/or decrease of the amount of SAR usage. As WiFi communication is continuously performed, data transmission or reception based on the cellular communication may be relatively less frequently performed. Accordingly, as shown in FIG. 15B, a cumulative SAR 1521 corresponding to the cellular communication may be identified as being increased slow.

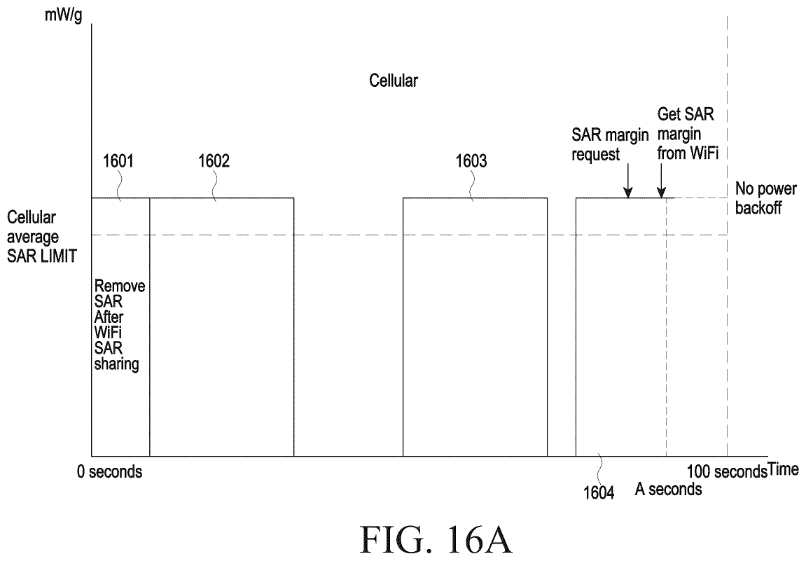

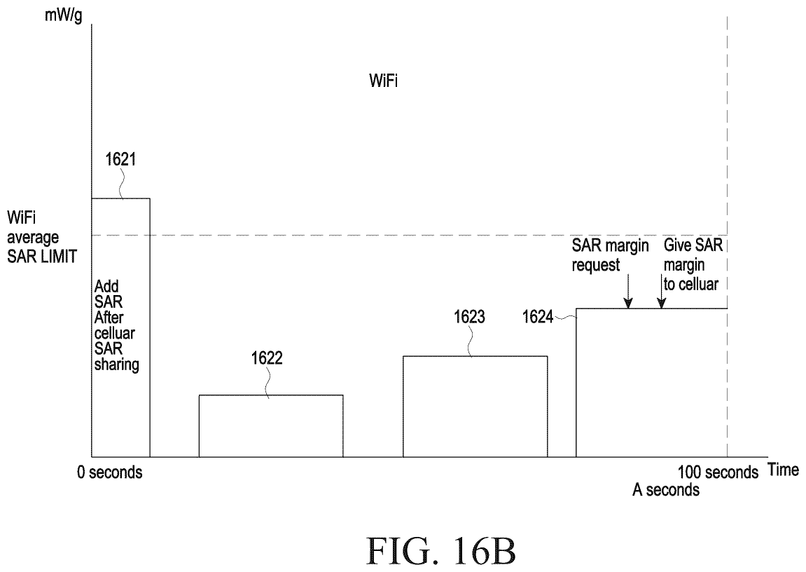

FIGS. 16A and 16B are diagrams illustrating an amount of SAR usage of each communication when an SAR margin is shared between WiFi communication and cellular communication in the same time scale according to various embodiments of the disclosure.

Referring to FIGS. 16A and 16B, according to an embodiment of the disclosure, a communication processor (e.g., first communication processor 212, second communication processor 214, and/or integrated communication processor 260) may perform data transmission or reception with a WiFi module. For example, when both the communication processor and WiFi module are in a wake-up state, the communication processor operates as a main device and the WiFi module operates as a secondary device, but this is not limited thereto. The communication processor and the WiFi module may share the amount of SAR usage at designated intervals (e.g., 1 seconds). The main device (e.g., communication processor), for example, may provide a maximum value of a transmission power and/or an SAR margin to the secondary device, but this is not limited thereto. When any one of the entities is in a sleep state, the entity in the sleep state may operate as a secondary device and the entity in a wake-up state may operate as a main device. For example, before entering a sleep state, any one entity may provide a cumulative SAR and/or sleep notification to the other entity. The entity that receives the sleep notification may operate as a main device. When the entity in the sleep state wakes up, the entity may provide a wake-up notification. The entity that receives the wake-up notification may provide information associated with a cumulative amount of SAR usage up to the present. Both entities may share data, for example, by sharing data via an interface, or writing/reading information via shared memory. For example, both entities may share information associated with the amount of SAR usage by using both the interface and shared memory.

When a cellular communication module requests an SAR margin from a WiFi communication module, the electronic device of the disclosure may calculate an SAR margin that remains and is transmittable from the WiFi module and transfer the same to the cellular communication. For example, the WiFi communication module may identify SARs 1622, 1623, and 1624 used up to the present, and may identify a magnitude of a transferrable SAR margin 1621. Sharing the SAR margin 1621 by the WiFi communication module may be the same as adding the corresponding SAR margin 1621 to the cumulative SAR from the perspective of the WiFi communication. The cellular communication module may receive the SAR margin 1621 from the WiFi module, and this may be the same as subtracting the corresponding SAR margin 1601 from the existing cumulative SAR. Accordingly, the cellular communication module may manage the cumulative SAR as a sum of 1602, 1603, and 1604 excluding the SAR margin 1601, as opposed to a sum of 1601, 1602, 1603, and 1604.

According to an embodiment of the disclosure, when at least one communication, such as WiFi communication, cellular communication, Bluetooth (BT) communication, and the like, is performed via an adjacent communication module, the electronic device may perform assignment for each communication based on a predetermined total SAR margin. In the case in which a fixed SAR margin is used, when an SAR margin remains in any one communication, another communication may use the remaining margin so that the total amount of SAR may be efficiently shared. For example, when an SAR margin of the WiFi communication is insufficient and an SAR margin of the cellular communication is sufficient, or when the SAR margin of the cellular communication is insufficient and the SAR margin of the WiFi communication is sufficient, an SAR margin may be transferred between the WiFi communication and cellular communication.

Here, the case in which an SAR margin remains may be the case that the remaining SAR margin is incapable of being used during the remaining time in a predetermined time scale. For example, when a time scale for an electronic device that supports a TAS operation is 100 seconds, an SAR available after excluding the amount of SAR capable of being used when operation is performed with a maximum power during the remaining 3 seconds from the perspective of an RF exposure amount table that elapses 97 seconds from the starting point, may be an SAR margin that is incapable of being used in the current tech/band state, and may be regarded as an SAR that may not cause any problem even when transmitted to another communication tech/band. The electronic device according to an embodiment of the disclosure may assign another communication (e.g., cellular or WiFi) the remaining SAR margin, and when an SAR backoff is needed in WiFi or cellular, they may share a remaining margin with each other so as to reduce backoff.

A transferable SAR margin (Transfer SAR Margin) according to an embodiment of the disclosure may be calculated according to Equation 1.

$$TransferSARMargin = RemainedSAR - RemainTime \times NormalMaxPowerSAR \qquad Equation 1$$

A transferable SAR margin obtained based on Equation 1 may be provided for each RF exposure amount table. In the case of an electronic device that performs communication with a plurality of networks, when Tech A (e.g., cellular communication) requests a margin (margin request) from Tech B (e.g., WiFi communication), Tech B transfers the Transfer SAR Margin obtained based on the above equation to Tech A, and a cumulative SAR limit of each RF exposure amount table of Tech A may be calculated based on a magnitude of a backoff for another tech from Tech B Transfer SAR Margin. For example, in the case of the electronic device according to an embodiment of the disclosure, a magnitude of a backoff in the cellular communication when WiFi communication is initiated may be a magnitude of SAR usage of the WIFI from the perspective of cellular, and an SAR margin that is transferred from the WIFI to the cellular communication may be obtained by multiplying a ratio of the SAR margin transferred by the WIFI and the magnitude of the backoff by cellular. For example, the electronic device of the disclosure may measure an SAR limit under the condition of simultaneous emissions in the WIFI and/or cellular communication, and the sum of two techs may be 100+100=150, instead of 100+100=200, like a vector sum, and this may be converted into equations expressed as given in Equations 2 to 4.

From cellular perspective
When Wi-Fi is off,
When Wi-Fi is on,
SAR used by Wi-Fi out of total SAR
Ratio of SAR between Wi-Fi and cellular
Transferred SAR Margin/Wi-Fi SAR cumulative MAX=ratio of Transferred SAR Margin to total WiFi SAR

$$Transferred SAR Margin = Z / X * ( Transfer SAR Margin / Wi - Fi SAR cumulative MAX ) * Cellular SAR cumulative MAX \qquad Equation 2$$

From Wi-Fi perspective
When cellular is off,
When cellular is on,
SAR used by cellular out of total SAR
Ratio of SAR between cellular and Wi-Fi
   Transfer SAR Margin/Cellular SAR cumulative MAX=Ratio of Transfer SAR Margin to Total Cellular SAR

$$Transferred SAR Margin = Z / X * ( Transfer SAR Margin / Cellular SAR cumulative MAX ) * Wi - Fi SAR cumulative MAX \qquad Equation 3$$

$$Cumulative SAR at entity that receives margin = Existing cumulative SAR \qquad Equation 4$$

$$Cumulative SAR at entity that transfers margin = Existing cumulative SAR$$

In Equations 2 to 4, examples of backoff based on initiation and/or termination of WIFI and/or cellular communication may be as given in Equation 4 below.

TABLE 4

| | | No | NR | | | RCV + |
|---|---|---|---|---|---|---|
| | | Cellular | Free | | RCV | NR |
| WIFI(2Tx) | Max Power | 20 dBm | 16 | dBm | 16 dBm | 13 dBm |
| Cellular | WIFI off | X | 23.5 | dBm | X | 20 dBm |
| | WIFI on | X | 22 | dBm | X | 18 dBm |

Transferred Time delay Margin in Equation 4 is an SAR margin that is lost due to a time difference caused by transferring an SAR margin between the cellular and WiFi communication, and a magnitude thereof may be calculated according to Equation 5 as given below.

$$Transferred Time delay Margin = Delay time \times Max Power SAR consumption \qquad Equation 5$$

For example, when Max Power is 23 dBm, the amount of SAR consumed is 3 W/KG, and Delay time is a maximum of 1 second, 3 W/KG may be calculated as Transferred Time delay Margin according to Equation 5.

In the electronic device according to an embodiment of the disclosure, a method of sharing WIFI and/or Cellular SAR Margin may be operated according to Cellular SAR Request->AP (RIL)->WIFI Return SAR Margin->AP (RIL)->Cellular and/or WIFI SAR Request->AP (RIL)->Cellular Return SAR Margin->AP (RIL)->WIFI. Specifically, an SAR margin sharing embodiment between techs/bands may be understood with reference to example 1 and example 2.

### Example 1

i. Transfer an SAR cumulative Max (100 W/kg) of each tech at first.

ii. Transfer an SAR margin for each second in the case of Return SAR Margin.

99-20, 98-16, 97-12, 96-8, 95-4, 94-0

1. 20 w/kg is transferred to a 99-second RF exposure table.

2. 16 w/kg is transferred to a 98-second RF exposure table.

3. 12 w/kg is transferred to a 97-second RF exposure table.

4. 8 w/kg is transferred to a 96-second RF exposure table.5. 4 w/kg is transferred to a 95-second RF exposure table.

6. 0 w/kg is transferred to a 94-second RF exposure table.

iii. Obtain a ratio by dividing the received SAR margin by the cumulative max SAR, and calculate this into an SAR of tech that receives the SAR.

### Example 2

i. Transfer an SAR margin ratio for each second in the case of Return SAR Margin.

ii. Calculate the radio into an SAR of tech that receives the SAR.

99-20, 98-16, 97-12, 96-8, 95-4, 94-0

1. 20% is transferred to a 99-second RF exposure table.

2. 16% is transferred to a 98-second RF exposure table.

3. 12% is transferred to a 97-second RF exposure table.

4. 8% is transferred to a 96-second RF exposure table.

5. 4% is transferred to a 95-second RF exposure table.

6. 0% is transferred to a 94-second RF exposure table.

According to an embodiment of the disclosure, the electronic device gradually assigns an SAR margin to the WIFI communication and/or cellular communication, and thus a communication tech/band that needs Tx transmission may use an SAR. Through the above, the frequency of backoff of a transmission power due to an insufficient SAR in any one tech/band may be reduced, and thus a TP of an entire terminal may be increased and a voice call (Voice call)'s muting (mute) or an RLF may be reduced.

According to an embodiment of the disclosure, the electronic device may share, between the WiFi communication and/or cellular communication, a method of gradually assigning an SAR margin and/or a shared SAR margin. Various embodiments of the disclosure are not limited to the mentioned tech/band, and various communications, such as Bluetooth (BT) or UWB, or the like may be applicable.

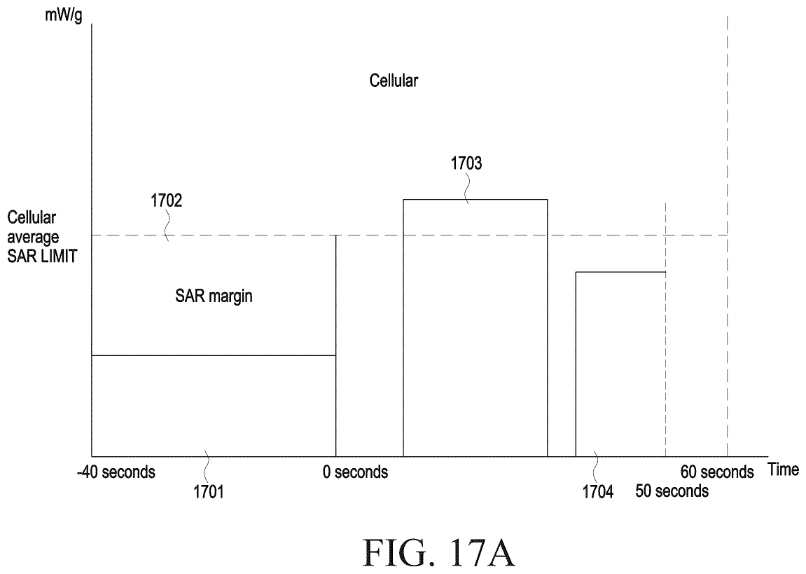

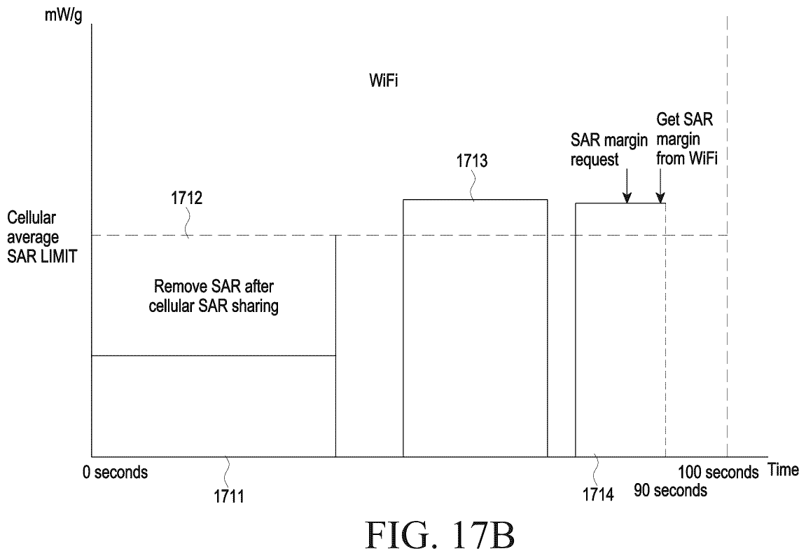

FIGS. 17A and 17B are diagrams illustrating an amount of SAR usage of each communication when an SAR margin is shared between WiFi communication and cellular communication in different time scales, according to various embodiments of the disclosure.

An electronic device according to an embodiment of the disclosure may have different time scales for WIFI and cellular in a TAS operation. For example, an SAR measurement time may be 100 seconds for average in the case of 3 GHz or less and an SAR measurement time may be 60 seconds in the case of 3 GHZ to 6 GHZ. Accordingly, the time scales (average time) of cellular and WiFi may be different from each other. In this instance, in a tech having a short time scale, an SAR that remains in a previous time may be transferred to another tech without taking into consideration a subsequent max power operation.

Referring to FIGS. 17A and 17B, they illustrate an operation of sharing an SAR margin, by an electronic device, with a time scale of 60 seconds in the cellular communication and a time scale of 100 seconds in the WiFi communication.

For example, when any one of the WiFi or cellular communication does not operate based on a time average SAR, the electronic device may operate as follows. For example, operation is performed based on a time average SAR, but a peak may be designated so that a power may not be greater than or equal to a predetermined power in a predetermined tech. Alternatively, any one of the WiFi or cellular communication may not operate based on a time average SAR, or may operate as if the operation were not based on a time average SAR, while operating based on a time average SAR. In this instance, a remaining SAR margin may be shared between techs.

For example, all power transmitted at a max power or less up to the present in a predetermined time scale may be regarded as an SAR margin, and the SAR margin may be immediately shared irrespective of a power at a future time point. In this instance, when an SAR margin is transferable between different techs, the SAR margin may be sum (Max Power SAR-Current Power SAR).

For example, in FIGS. 17A and 17B, based on expecting that an SAR fail does not occur based on a cumulative SAR 1702, 1703, and 1704 in cellular communication, an SAR margin 1701 may be assigned to WiFi communication. The assignment of the SAR margin 1701 may be the same as adding the corresponding SAR margin 1701 to a cumulative SAR from the perspective of the cellular communication. Accordingly, the cumulative SAR of the cellular communication may be managed as a sum of 1701, 1702, 1703, and 1704. In addition, a cumulative SAR of the WiFi communication may be configured to a sum of 1711, 1713, and 1714 excluding the SAR margin 1712 from a sum of 1711, 1712, 1713, and 1714. Accordingly, the backoff of a maximum value of a transmission power may not be performed, or a backoff time may be delayed.

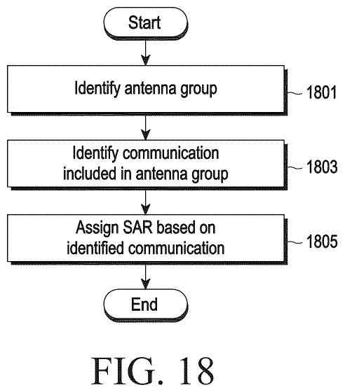

FIG. 18 is a flowchart illustrating an operation method of an electronic device according to an embodiment of the disclosure.

Referring to FIG. 18, according to an embodiment of the disclosure, the electronic device may identify an antenna group in operation 1801. In operation 1803, the electronic device may identify communication included in the identified antenna group. For example, the electronic device may identify at least one communication that each of the at least one antenna included in the antenna group corresponds to. In operation 1805, based on the identified communication, the electronic device may identify the amount of SAR assigned for each communication. For example, Table 5 is a lookup table of the amount of SAR assigned to Bluetooth communication for each identified communication case of the example.

TABLE 5

| | SAR Margin of First |
|---|---|
| | Antenna Group (%) |
| (Cellular Communication and WiFi | 50% |
| Communication) | |
| Bluetooth Communication | 90% |
| Bluetooth Communication and (Cellular | 30% |
| Communication and WiFi | |
| Communication Use One Transmission | |
| RF Path) | |
| Bluetooth Communication and (Cellular | 20% |
| Communication and WiFi | |
| Communication Use Two | |
| Transmission RF Paths) | |

For example, when the cellular communication and WiFi communication are activated, the electronic device may assign 50% of the SAR assigned to an antenna group to the Bluetooth communication. For example, when only the Bluetooth communication is activated, the electronic device may assign 90% of the SAR assigned to the antenna group to the Bluetooth communication. For example, when Bluetooth communication is activated and the cellular communication and WiFi communication use a single transmission RF path, the electronic device may assign 30% of the SAR assigned to the antenna group to the Bluetooth communication. For example, when Bluetooth communication is activated and the cellular communication and WiFi communication use two transmission RF paths, the electronic device may assign 20% of the SAR assigned to the antenna group to the Bluetooth communication.

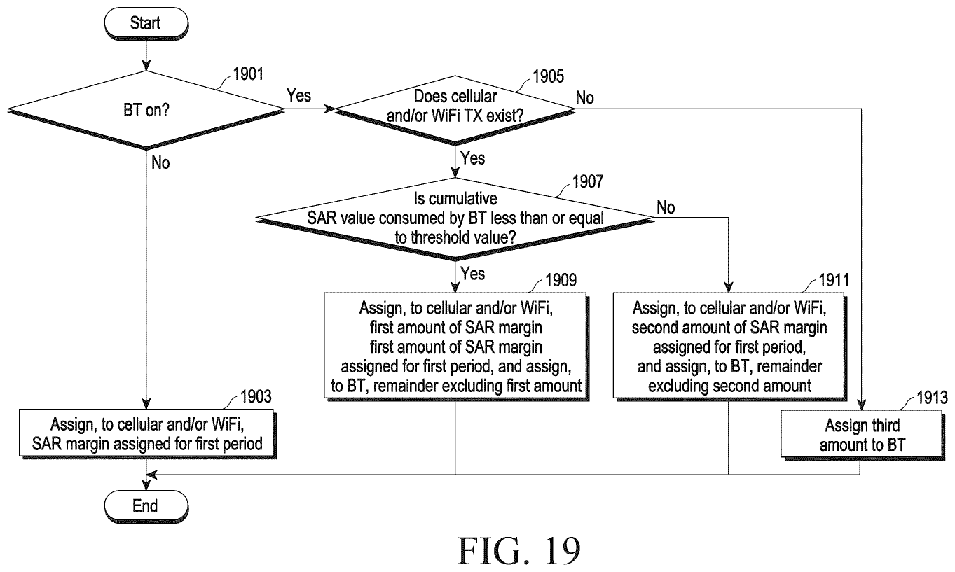

FIG. 19 is a flowchart illustrating an operation method of an electronic device according to an embodiment of the disclosure.

Referring to FIG. 19, according to an embodiment of the disclosure, the electronic device may identify whether a Bluetooth module is turned on (or in an active state) in operation 1901. When the Bluetooth module is not turned on (or not in an active state) (No in operation 1901), the electronic device may assign cellular communication and/or WiFi communication an SAR margin assigned to one antenna group in operation 1903. When the Bluetooth module is turned on (or in an active state) (Yes in operation 1901), the electronic device may identify whether cellular communication and/or WiFi communication-based transmission data exists in operation 1905. Alternatively, the electronic device may identify whether a cellular communication and/or WiFi communication-based antenna is included in the corresponding antenna group. When the cellular communication-based transmission data does not exist (No in operation 1905), the electronic device may assign a third amount of the SAR margin (e.g., 90% of the assigned SAR margin but not limited thereto) to the Bluetooth communication in operation 1913. When the cellular communication and/or WiFi communication-based transmission data exists (Yes in operation 1905), the electronic device may identify whether a cumulative SAR value consumed by the Bluetooth communication is less than or equal to a threshold value in operation 1907. When the cumulative SAR value consumed by the Bluetooth module is less than or equal to the threshold value (Yes in operation 1907), the electronic device may assign a first amount (e.g., 90%) of the SAR margin assigned for a first period to the cellular communication and/or WiFi communication, and may assign the remainder (e.g., 10%) excluding the first amount to the Bluetooth communication in operation 1909. When the cumulative SAR value consumed by the Bluetooth communication exceeds the threshold value (No in operation 1907), the electronic device may assign a second amount (e.g., 70%) of the SAR margin assigned for the first period to the cellular communication and/or WiFi communication, and may assign the remainder (e.g., 30%) excluding the second amount to the Bluetooth communication in operation 1911.

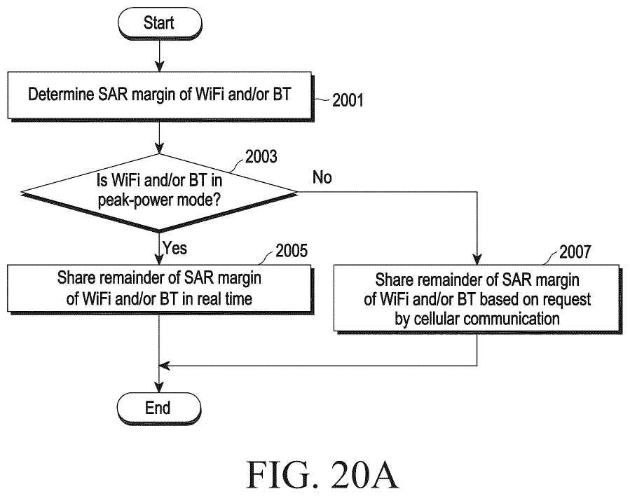

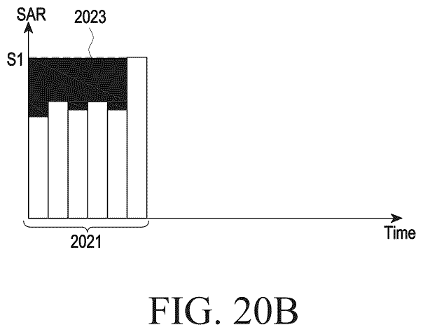

FIG. 20A is a flowchart illustrating an operation method of an electronic device according to an embodiment of the disclosure.

The embodiment of FIG. 20A will be described with reference to FIG. 20B.

FIG. 20B is a diagram illustrating an SAR that occurs based on Bluetooth communication according to an embodiment of the disclosure.

Referring to FIG. 20B, according to an embodiment of the disclosure, the electronic device may determine an SAR margin of WiFi and/or BT in operation 2001. The SAR margin of each communication may be determined, for example, based on an available SAR magnitude or ratio relative to a total SAR, and/or a maximum transmission power available for each communication, but this is not limited thereto. The electronic device may identify whether WiFi and/or BT is in a peak-power mode in operation 2003. The peak-power mode, for example, may be a mode in which transmission is performed at a transmission power less than or equal to a predetermined power (this is referred to as a peak-power). For example, a hearing aid may require not to cause noise greater than or equal to a predetermined magnitude, and the peak-power mode may be configured therefor. When it is required not to change a transmission power as a maximum transmission power magnitude changes based on an SAR, the peak-power mode may be configured. Alternatively, the peak-power mode may be configured in a country that does not support time average SAR regulations. At least a portion of multiple communication schemes supported by the electronic device may be configured to operate in the peak-power mode, and the remainder may operate based on time average SAR regulations. For example, at least one of cellular communication, Bluetooth communication, and/or WiFi communication may operate in the peak-power mode. In this instance, a remaining margin of communication that operates in the peak-power mode may be shared with another communication without a delay in time.

According to an embodiment of the disclosure, when WiFi and/or BT operates in the peak-power mode (Yes in operation 2003), the electronic device may share a remainder of the SAR margin of WiFi and/or BT with the cellular communication in real time in operation 2005. For example, FIG. 20B illustrates an SAR 2021 consumed by BT when BT operates in the peak-power mode. Based on BT operating in the peak-power mode, the electronic device may share a remainder 2023 of the SAR of the BT with the cellular communication in real time. The electronic device may share the remainder 2023 of the SAR immediately with the cellular communication without taking into consideration a future SAR expected to be consumed by the BT. When the WiFi and/or BT is not in the peak-power mode (No in operation 2003), the electronic device may share a remainder of the SAR of BT and/or WiFi based on, for example, a request by the cellular communication in operation 2007. Those skilled in the art may understand that the Bluetooth communication, cellular communication, and WiFi communication are merely examples, and the type of communication is not limited.

For example, a communication entity that operates in the peak-power mode may transfer a transmission power to another communication entity in real time. For example, the other entity that receives the related information may add, to the overall SAR margin of the corresponding communication, a remaining SAR that is identified based on a difference between a maximum transmission power and a current transmission power (max power-current power), in real time.

For example, a communication entity that operates in the peak-power mode may transfer an average (or sum) of transmission powers identified during a predetermined time (e.g., measurement period) to another communication entity. For example, the other communication entity that receives the related information may identify a remaining SAR based on the received averaged transmission power. For example, based on a maximum value of a transmission power corresponding to a communication that operates in the peak-power mode, and the received averaged transmission power (Max Power assigned to tech operating in Peak Power-received average Power), the remaining SAR may be identified, but this is not limited thereto. The other communication entity may add the remaining SAR to the overall SAR margin of the corresponding communication.

For example, a communication entity that operates in the peak-power mode may transfer, to another communication entity, a magnitude of an SAR remaining after using a predetermined time. For example, the other communication entity that receives the related information may add the received remaining SAR to the overall SAR margin of the corresponding communication.

An electronic device according to an embodiment of the disclosure may include a WiFi module for WiFi communication and at least one communication processor for at least one cellular communication, and the at least one communication processor may be configured to, based on identifying that the WiFi module is in an OFF state, assign an overall SAR margin assigned to the electronic device for a first period to the at least one cellular communication.

The electronic device according to an embodiment of the disclosure, based on identifying that the WiFi module is in an ON state and a cumulative SAR value consumed by the WiFi module is less than or equal to a threshold value, may be configured to assign a first amount of the SAR margin assigned for the first period to the WiFi communication and assign the remaining amount excluding the first amount to the at least one cellular communication.

The electronic device according to an embodiment of the disclosure, based on identifying that the WiFi module is in an ON state and the cumulative SAR value consumed by the WiFi module exceeds the threshold value, may be configured to assign a second amount of the SAR margin assigned for the first period, which is greater than the first amount, to the WiFi communication and assign the remaining amount excluding the second amount to the at least one cellular communication.

In the electronic device according to an embodiment of the disclosure, the at least one communication processor may identify whether a voice call (VoWiFi) operation of the WiFi communication is performed.

In the electronic device according to an embodiment of the disclosure, the communication processor, when the voice call operation of the WiFi communication is performed, may be configured to assign a third amount of the SAR margin assigned for the first period, which is greater than the second amount, to the WiFi communication and assign the remaining amount excluding the third amount to the at least one cellular communication.

In the electronic device according to an embodiment of the disclosure, the at least one communication processor may be configured to identity whether a voice call operation of the cellular communication is performed.

In the electronic device according to an embodiment of the disclosure, the at least one communication processor, when the voice call operation of the cellular communication is performed, may be configured to assign a fourth amount of the SAR margin assigned for the first period, which is greater than the first amount and less than the second amount, to the WiFi communication and assign the remaining amount excluding the fourth amount to the at least one cellular communication.

In the electronic device according to an embodiment of the disclosure, the at least one communication processor may be configured to identify whether the cumulative SAR value consumed by the WiFi module exceeds a first threshold value, and when the cumulative SAR value exceeds the first threshold value, to assign a first-first amount to the WiFi communication.

In the electronic device according to an embodiment of the disclosure, the at least one communication processor may be configured to identify whether the cumulative SAR value consumed by the WiFi module exceeds a second threshold value that is greater than the first threshold value, and when the cumulative SAR value exceeds the second threshold value, to assign a first-second amount that is greater than the first-first amount to the WiFi communication.

In the electronic device according to an embodiment of the disclosure, the at least one communication processor, when identifying that the voice call operation of the WiFi communication is not performed and the voice call operation of the cellular communication is performed, may be configured to assign a fourth amount of the SAR margin assigned for the first period, which is greater than the first amount and is less than the second amount, to the WiFi communication and to assign the remaining amount excluding the fourth amount to the at least one cellular communication.

In the electronic device according to an embodiment of the disclosure, the at least one communication processor, when the cellular communication is performed intermittently, may be configured to assign a small SAR margin to the cellular communication.

In the electronic device according to an embodiment of the disclosure, the at least one communication processor may be configured to assign a total amount of the SAR margin for the first period to the cellular communication and the WiFi communication at a predetermined ratio.

In the electronic device according to an embodiment of the disclosure, the predetermined ratio may be adjusted to a ratio corresponding to a predetermined event identified by the electronic device.

In the electronic device according to an embodiment of the disclosure, at least one of the cellular communication and the WiFi communication may support a time average SAR operation.

In the electronic device according to an embodiment of the disclosure, prior to backoff in one of the cellular communication and WiFi communication using the SAR margin assigned for the first period, the at least one communication processor may be configured to request a remaining SAR margin from the other one of the cellular communication and the WiFi communication.

An electronic device according to an embodiment of the disclosure may perform WiFi communication and cellular communication.

A method of the electronic device according to an embodiment of the disclosure, based on identifying that WiFi communication is not performed, may perform assigning an overall SAR margin assigned to the electronic device for a first period to the cellular communication.

The method of the electronic device according to an embodiment of the disclosure may perform, based on identifying that the WiFi communication is performed and a cumulative SAR value consumed by performing the WiFi communication is less than or equal to a threshold value, assigning a first amount of the SAR margin assigned for the first period to the WiFi communication, and assigning the remaining amount excluding the first amount to the cellular communication.

The method of the electronic device according to an embodiment of the disclosure may include, assigning a second amount of the SAR margin assigned for the first period, which is greater than the first amount to the WiFi communication, and assigning the remaining amount excluding the second amount to the cellular communication, based on identifying that the WiFi communication is performed and the cumulative SAR value consumed by performing the WiFi communication exceeds the threshold value.

The method of the electronic device according to an embodiment of the disclosure may identify whether a voice call (VoWiFi) operation of the WiFi communication is performed.

The method of the electronic device according to an embodiment of the disclosure may further include assigning a third amount of the SAR margin assigned for the first period, which is greater than the second amount, to the WiFi communication and assigning the remaining amount excluding the third amount to the at least one cellular communication, when the voice call operation of the WiFi communication is performed.

The method of the electronic device according to an embodiment of the disclosure may identify whether a voice call operation of the cellular communication is performed.

The method of the electronic device according to an embodiment of the disclosure may further include assigning a fourth amount of the SAR margin assigned for the first period, which is greater than the first amount and less than the second amount, to the WiFi communication and assigning the remaining amount excluding the fourth amount to the at least one cellular communication, when the voice call operation of the cellular communication is performed.

In the method of the electronic device according to an embodiment of the disclosure, the identifying that the cumulative SAR value consumed by the WiFi communication exceeds the threshold value may include identifying whether the cumulative SAR value consumed by the WiFi communication exceeds a first threshold value, and when the cumulative SAR value exceeds the first threshold value, assigning a first-first amount to the WiFi communication.

The method of the electronic device according to an embodiment of the disclosure may include identifying whether the cumulative SAR value consumed by the WiFi communication exceeds a second threshold value greater than the first threshold value, and when the cumulative SAR value exceeds the second threshold value, assigning a first-second amount that is greater than the first-first amount to the WiFi communication.

The method of the electronic device according to an embodiment of the disclosure, when identifying that the voice call operation of the WiFi communication is not performed and the voice call operation of the cellular communication is performed, may perform assigning a fourth amount of the SAR margin assigned for the first period, which is greater than the first amount and less than the second amount, to the WiFi communication and assigning the remaining amount excluding the fourth amount to the at least one cellular communication.

The method of the electronic device according to an embodiment of the disclosure, when the cellular communication is performed intermittently, may assign a small SAR margin to the cellular communication.

The method of the electronic device according to an embodiment of the disclosure may assign a total amount of the SAR margin for the first period to the cellular communication and the WiFi communication at a predetermined ratio.

In the method of the electronic device according to an embodiment of the disclosure, the predetermined ratio is adjusted to a ratio corresponding to a predetermined event identified by the electronic device.

In the method of the electronic device according to an embodiment of the disclosure, at least one of the cellular communication and the WiFi communication may support a time average SAR operation.

The method of the electronic device according to an embodiment of the disclosure, prior to backoff in one of the cellular communication and WiFi communication using the SAR margin assigned for the first period, may perform requesting a remaining SAR margin from the other one of the cellular communication and the WiFi communication.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a wireless fidelity (WiFi) module for WiFi communication;
memory storing one or more computer programs; and
at least one communication processor, for at least one cellular communication, communicatively coupled to the WiFi module and the memory,
wherein the one or more computer programs include computer-executable instructions that, when executed by the at least one communication processor individually or collectively, cause the electronic device to:
based on identifying that the WiFi module is in an OFF state, assign an overall specific absorption rate (SAR) margin assigned to the electronic device for a first period to the at least one cellular communication,
based on identifying that the WiFi module is in an ON state and a cumulative SAR value consumed by the WiFi module is less than or equal to a threshold value, assign a first amount of the SAR margin assigned for the first period to the WiFi communication and assign a remaining amount excluding the first amount to the at least one cellular communication, and
based on identifying that the WiFi module is in an ON state and the cumulative SAR value consumed by the WiFi module exceeds the threshold value, assign a second amount of the SAR margin assigned for the first period to the WiFi communication, which is greater than the first amount, and assign a remaining amount excluding the second amount to the at least one cellular communication.

2. The electronic device of claim 1, wherein the one or more computer programs further include computer-executable instructions that, when executed by the at least one communication processor individually or collectively, cause the electronic device to:
identify whether a voice call (VoWiFi) operation of the WiFi communication is performed, and
in case that the voice call operation of the WiFi communication is performed, assign a third amount of the SAR margin assigned for the first period to the WiFi communication, which is greater than the second amount, and assign a remaining amount excluding the third amount to the at least one cellular communication.

3. The electronic device of claim 1, wherein the one or more computer programs further include computer-executable instructions that, when executed by the at least one communication processor individually or collectively, cause the electronic device to:
identity whether a voice call operation of the cellular communication is performed, and
in case that the voice call operation of the cellular communication is performed, assign a fourth amount of the SAR margin assigned for the first period, which is greater than the first amount and less than the second amount to the WiFi communication, and assign a remaining amount excluding the fourth amount to the at least one cellular communication.

4. The electronic device of claim 1, wherein the identifying, by the at least one communication processor, that the cumulative SAR value consumed by the WiFi module exceeds the threshold value, comprises:
identifying whether the cumulative SAR value consumed by the WiFi module exceeds a first threshold value, and in case that the cumulative SAR value exceeds the first threshold value, assigning a first-first amount to the WiFi communication; and
identifying whether the cumulative SAR value consumed by the WiFi module exceeds a second threshold value that is greater than the first threshold value, and in case that the cumulative SAR value exceeds the second threshold value, assigning a first-second amount that is greater than the first-first amount to the WiFi communication.

5. The electronic device of claim 3, wherein the one or more computer programs further include computer-executable instructions that, when executed by the at least one communication processor individually or collectively, cause the electronic device to, in case that identifying that the voice call operation of the WiFi communication is not performed and the voice call operation of the cellular communication is performed, assign a fourth amount of the SAR margin assigned for the first period, which is greater than the first amount and is less than the second amount, to the WiFi communication and assign a remaining amount excluding the fourth amount to the at least one cellular communication.

6. The electronic device of claim 1, wherein the one or more computer programs further include computer-executable instructions that, when executed by the at least one communication processor individually or collectively, cause the electronic device to, in case that the cellular communication is performed intermittently, assign a small SAR margin to the cellular communication.

7. The electronic device of claim 1,
wherein the one or more computer programs further include computer-executable instructions that, when executed by the at least one communication processor individually or collectively, cause the electronic device to assign a total amount of the SAR margin for the first period to the cellular communication and the WiFi communication at a predetermined ratio, and
wherein the predetermined ratio is adjusted to a ratio corresponding to a predetermined event identified by the electronic device.

8. The electronic device of claim 1, wherein at least one of the cellular communication and the WiFi communication supports a time average SAR operation.

9. The electronic device of claim 1, wherein the one or more computer programs further include computer-executable instructions that, when executed by the at least one communication processor individually or collectively, cause the electronic device to, prior to backoff in one of the cellular communication and WiFi communication using the SAR margin assigned for the first period, request a remaining SAR margin from the other one of the cellular communication and the WiFi communication.

10. The electronic device of claim 1, wherein a distance between a first antenna based on the cellular communication and a second antenna based on the WiFi communication is less than a threshold distance.

11. A method performed by an electronic device performing wireless fidelity (WiFi) communication and cellular communication, the method comprising:
based on identifying that WiFi communication is not performed, assigning, by the electronic device, an overall specific absorption rate (SAR) margin assigned to the electronic device for a first period to the cellular communication;
based on identifying that the WiFi communication is performed and a cumulative SAR value consumed by performing the WiFi communication is less than or equal to a threshold value, assigning, by the electronic device, a first amount of the SAR margin assigned for the first period to the WiFi communication, and assigning a remaining amount excluding the first amount to the cellular communication; and
based on identifying that the WiFi communication is performed and the cumulative SAR value consumed by performing the WiFi communication exceeds the threshold value, assigning, by the electronic device, a second amount of the SAR margin assigned for the first period, which is greater than the first amount, to the WiFi communication and assigning the remaining amount excluding the second amount to the cellular communication.

12. The method of claim 11, further comprising:
identifying whether a voice call (VoWiFi) operation of the WiFi communication is performed; and
in case that the voice call operation of the WiFi communication is performed, assigning a third amount of the SAR margin assigned for the first period, which is greater than the second amount, to the WiFi communication and assigning a remaining amount excluding the third amount to the cellular communication.

13. The method of claim 11, further comprising:
identifying whether a voice call operation of the cellular communication is performed; and
in case that the voice call operation of the cellular communication is performed, assigning a fourth amount of the SAR margin assigned for the first period to the WiFi communication, which is greater than the first amount and less than the second amount, and assigning a remaining amount excluding the fourth amount to the cellular communication.

14. The method of claim 11, wherein the identifying that the cumulative SAR value consumed by the WiFi communication exceeds the threshold value comprises:
identifying whether the cumulative SAR value consumed by the WiFi communication exceeds a first threshold value, and in case that the cumulative SAR value exceeds the first threshold value, assigning a first-first amount to the WiFi communication; and
identifying whether the cumulative SAR value consumed by the WiFi communication exceeds a second threshold value greater than the first threshold value, and in case that the cumulative SAR value exceeds the second threshold value, assigning a first-second amount that is greater than the first-first amount to the WiFi communication.

15. The method of claim 13, comprising, in case that identifying that the voice call operation of the WiFi communication is not performed and the voice call operation of the cellular communication is performed, assigning a fourth amount of the SAR margin assigned for the first period, which is greater than the first amount and less than the second amount, to the WiFi communication and assigning a remaining amount excluding the fourth amount to the cellular communication.

16. The method of claim 11, further comprising:
in case that the cellular communication is performed intermittently, assign a small SAR margin to the cellular communication.

17. The method of claim 11, further comprising:
assigning a total amount of the SAR margin for the first period to the cellular communication and the WiFi communication at a predetermined ratio,
wherein the predetermined ratio is adjusted to a ratio corresponding to a predetermined event identified by the electronic device.

18. The method of claim 11, wherein at least one of the cellular communication and the WiFi communication supports a time average SAR operation.

19. One or more non-transitory computer-readable storage media storing one or more computer programs including computer-executable instructions that, when executed by at least one communication processor of an electronic device performing wireless fidelity (WiFi) communication and cellular communication, cause the electronic device to perform operations, the operations comprising
based on identifying that WiFi communication is not performed, assigning, by the electronic device, an overall specific absorption rate (SAR) margin assigned to the electronic device for a first period to the cellular communication;
based on identifying that the WiFi communication is performed and a cumulative SAR value consumed by performing the WiFi communication is less than or equal to a threshold value, assigning, by the electronic device, a first amount of the SAR margin assigned for the first period to the WiFi communication, and assigning a remaining amount excluding the first amount to the cellular communication; and
based on identifying that the WiFi communication is performed and the cumulative SAR value consumed by performing the WiFi communication exceeds the threshold value, assigning, by the electronic device, a second amount of the SAR margin assigned for the first period, which is greater than the first amount, to the WiFi communication and assigning a remaining amount excluding the second amount to the cellular communication.

20. The one or more non-transitory computer-readable storage media of claim 19, the operations further comprising:
identifying whether a voice call (VoWiFi) operation of the WiFi communication is performed; and
in case that the voice call operation of the WiFi communication is performed, assigning a third amount of the SAR margin assigned for the first period, which is greater than the second amount, to the WiFi communication and assigning a remaining amount excluding the third amount to the cellular communication.
